(19) United States
(12) Patent Application Publication
(10) Pub. No.: US 2012/0320080 A1
(43) Pub. Date: Dec. 20, 2012

(54) MOTION BASED VIRTUAL OBJECT NAVIGATION

(75) Inventors: William Giese, Snohomish, WA (US); David E. Gierok, Sammamish, WA (US); Matthew Jay Monson, Kirkland, WA (US); AbdulWajid Mohamed, Redmond, WA (US); David M. Eichorn, Redmond, WA (US); Rhett Alexander Mathis, Snohomish, WA (US); Rory Reich, Seattle, WA (US)

(73) Assignee: MICROSOFT CORPORATION, Redmond, WA (US)

(21) Appl. No.: 13/324,691

(22) Filed: Dec. 13, 2011

Related U.S. Application Data
(60) Provisional application No. 61/496,943, filed on Jun. 14, 2011.

(51) Int. Cl. G09G 5/00

(52) U.S. Cl. 345/619

(57) ABSTRACT

A system and method providing a human controlled user interface for navigating around a virtual object when a user is in a confined physical space. A virtual object comprising a representation of an exterior of a real world object is presented on a display. A set of interactive elements may be added to the physical object, the interactive elements providing additional information regarding the physical object when engaged by the user. User movements are tracked within the confined space adjacent to the display. The virtual perspective of the user is then altered about the physical object coincident with the user movement in the confined space. When a user selects an interactive element, additional information associated with the virtual object is provided. The information can include at least a different visual perspective of a second portion of the virtual object.

### CLAIM OF PRIORITY

The present application claims priority to U.S. Provisional Patent Application No. 61/496,943, entitled “Motion Based Virtual Vehicle Game Navigation,” filed Jun. 14, 2011, which application is incorporated by reference herein in its entirety.

### BACKGROUND

In the past, computing applications such as computer games and multimedia applications have used controllers, remotes, keyboards, mice, or the like to allow users to manipulate game characters or other aspects of an application. More recently, computer games and multimedia applications have begun employing cameras and motion recognition to provide a human computer interface (“HCI”). With HCI, user gestures are detected, interpreted and used to control game characters or other aspects of an application.

One limitation of a HCI is that translation between the physical environment and a virtual environment is the limitation between the physical environment and a relatively unlimited virtual environment. In a virtual world, the virtual space in a game world is unlimited.

### SUMMARY

Technology is provided to enable a user experience interaction and navigation with a tangible object, such as a vehicle, in a relatively unlimited space in a three dimensional virtual environment. The technology provides the user with an experience being able to navigate around a virtual environment, and in particular, a physical three-dimensional object in the virtual environment, using natural motions of a user in a limited physical environment. Interactive elements may be provided on the three dimensional object allowing the user to interact with the three dimensional object. For example, a user can walk around various different types of vehicles and with the ability to interact with the main features of the vehicles. In one embodiment, a user can lean over and peek into a window of an exotic car, open the engine compartment on a vehicle, start the vehicle, and otherwise interact with the vehicles in a relatively lifelike manner. Motion control of an interface is provided. The interface may include a cursor on a display which may be positioned over pins indicating points of interests on the vehicle. The cursor may be positioned by a user's movement of the user's hand which is detected by a capture device as discussed below. A user may, for example, raise his hand and use a hover selection over an icon to activate an on-screen option.

In a motion controlled vehicle navigation system, a vehicle exploration experience is provided wherein a user is presented with a rendered vehicle. When a user physically moves forward in front of a capture device, the user's camera perspective within the game relative to the vehicle moves forward (toward the vehicle); when the user tilts left, the camera tilts or moves left (with or without tilting).

In one aspect, a system and method providing a human controlled user interface for navigating around a virtual object when a user is in a confined physical space is provided. A virtual object comprising a representation of an exterior of a real world object is presented on a display. A set of interactive elements may be added to the physical object, the interactive elements providing additional information regarding the physical object when engaged by the user. User movements are tracked within the confined space adjacent to the display. The virtual perspective of the user is then altered about the physical object coincident with the user movement in the confined space. When a user selects an interactive element, additional information associated with the virtual object is provided. The information can include at least a different visual perspective of a second portion of the virtual object.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1 and 2 illustrate one embodiment of a target recognition, analysis and tracking system with a user performing a gesture to control a user-interface.

FIG. 3 illustrates one embodiment of a capture device that may be used as part of the tracking system.

FIG. 4 is a flowchart describing one embodiment of a process for tracking user motion.

FIG. 5 is an example of a skeletal model of a human target that can be generated by a tracking system in one embodiment.

FIG. 6 is a flowchart describing one embodiment of a process for capturing motion to control a user interface.

FIG. 7 is a flowchart describing one embodiment of a providing a human controlled virtual object navigation and interaction interface.

FIG. 8 is a flowchart illustrating one sequence of providing a human controlled virtual object navigation and interaction interface for entering a vehicle.

FIG. 9 illustrates an embodiment of a human controlled vehicle selection interface.

FIG. 10 illustrates a virtual perspective of a user in virtual space.

FIGS. 11-14b illustrate user navigation motions relative to a display and capture device.

FIG. 15a illustrates a basic example of POI pins on the exterior of a vehicle.

FIG. 15b illustrates a portion of a non-interactive, animated sequence on a virtual object.

FIG. 16 illustrates an alternative virtual perspective in a portion of a non-interactive, animated sequence provided following user interaction with a virtual POI pin.

FIG. 17 is an illustration of the near and far proximity parameters.

FIG. 18 is an illustration of standing and crouching height parameters.

FIGS. 19-21 are an illustration of the upright and bowing bend parameters.

FIGS. 22-23 illustrate the standing and crouching angle parameters when a user is bending.

FIG. 24-26 illustrate the player pitch and pitch scale translation.

FIGS. 27 and 28 illustrate the ExteriorYawScaleStanding and ExteriorYawScaleCrouching parameters.

FIG. 29 illustrates interior position coordinate system and parameters used when a user is inside a vehicle within the motion based vehicle navigation experience.

FIG. 30 illustrates exterior focusing parameters used in a motion based vehicle navigation experience.

FIG. 31 illustrates the exterior distance parameters utilized in determining how far and near a person is to a vehicle in a motion based vehicle navigation experience.

FIGS. 32 and 33 illustrates virtual field of view parameters in a motion based vehicle navigation experience.

FIG. 34 illustrates the minimum and maximum distance from the capture device after which no effect on the virtual perspective movement within the game occurs.

FIG. 35 illustrates parameters utilized to illustrate a user walking around the vehicle.

FIGS. 36 and 37 illustrate the vehicle walk around path and various facing directions at various distances.

FIG. 38 illustrates a vehicle coordinate system for use with the present technology.

FIG. 39 illustrates the axis yaw degrees relative to the vehicle.

FIG. 40 illustrates the apex value of how the fade in and fade out of each pin may be controlled.

FIG. 41 illustrates the Axis pitch relative to the vehicle in the motion based vehicle navigation system.

FIG. 42 illustrates the apex pitch relative to the vehicle.

FIG. 43 illustrates an exemplary gaming console device.

FIG. 44 illustrates an exemplary processing device in accordance with the present technology.

### DETAILED DESCRIPTION

Technology is provided to enable a user experience interaction and navigation with a tangible object in a three dimensional virtual environment. In one embodiment, the object is a vehicle and the environment is a motion-controlled vehicle game using a motion capture device. The technology provides game players with a level of interactivity when interacting with vehicles in the game. The technology provides the user with an experience being able to walk around various different types of vehicles and with the ability to interact with the main features of the vehicles. In one embodiment, a user can lean over and peek into a window of an exotic vehicle, open the engine compartment on a vehicle, start the vehicle, and otherwise interact with the vehicles in a relatively lifelike manner.

From an interactive main menu, a user may select to experience a three dimensional object, such as a vehicle. In one embodiment, a user experiences a main menu activation screen which the user then utilizes to select various navigation elements of the experience. Motion control of an interface is provided. The interface may include a cursor on a display which may be positioned over pins indicating points of interests on the vehicle. The cursor may be positioned by a user's movement of the user's hand which is detected by a capture device as discussed below. A user may, for example, raise his hand and use a hover selection over an icon to activate on on-screen option.

In a motion controlled vehicle game, a vehicle exploration experience is provided wherein a user is presented with a virtually rendered vehicle. When a user moves in front of a capture device, the user's camera perspective within the game relative to the vehicle moves in relation to the user's physical movement. If a user moves forward, the perspective and appearance of the vehicle changes (toward the vehicle); when the user tilts left, the camera tilts left, etc.

The interface can respond to gestures and movement “tracking” in that they are continuous in input and output, focusing on whatever simple movement occurs and translating that rather than attempting to discern a discreet movement sequence.

As the user approaches the vehicle, points of interest appear on various parts of the vehicle. These points of interest allow the user to select each point using the user's hand by hovering the hand over one of the “pins” which visually represents an action item within the game. For example, if a pin is placed on a door and selected, the door opens and gives the user a chance to look into the vehicle. If another pin is shown over the driver's seat is selected, a transition into the vehicle occurs. A pin placed on the door can allow the user to close the door once the user is in the vehicle. The game includes muffling of ambient sounds as they would appear muffled if the user were actually in a real vehicle with closed doors. A pin on the dashboard may allow the user to start a fully integrated animation and virtual experience of the engine start up sequence with dashboard gauges coming alive and a tour of the dashboard and camera shake as the vehicle starts. Once the start up sequence is done, camera controls return to the user as the engine is still running at idle. The user can look around the cockpit, lean left and right, step forward and backwards to get a closer look at accurately representing gauges, knobs, and features of the vehicle. Exiting the vehicle may be performed by selecting an exit pin by the vehicle door placing the user back outside the vehicle looking back at the vehicle.

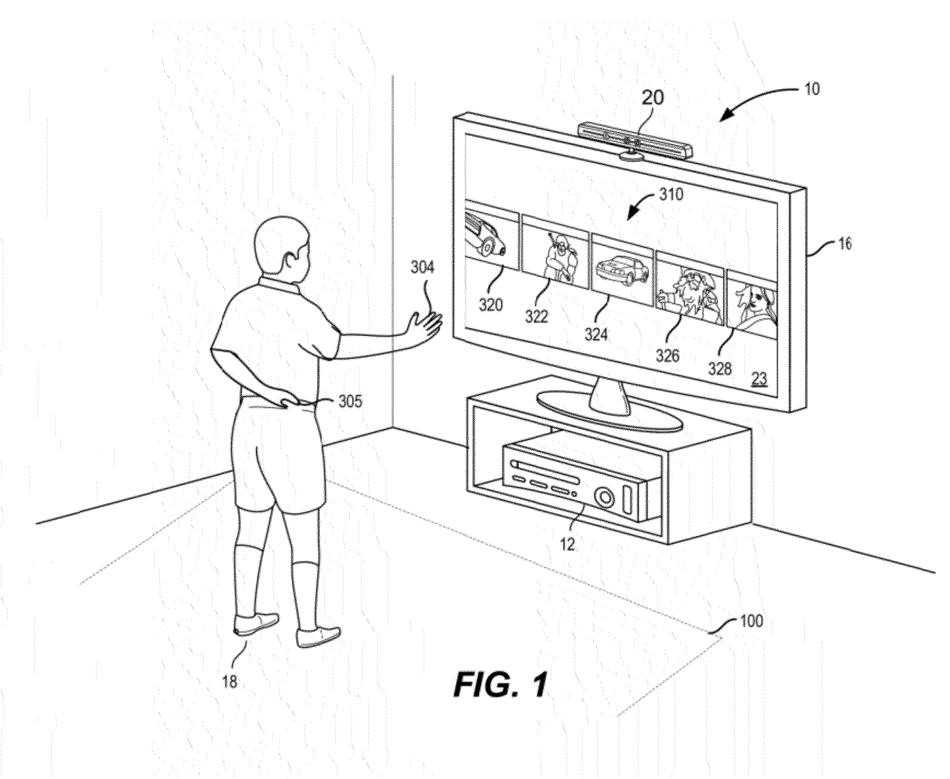

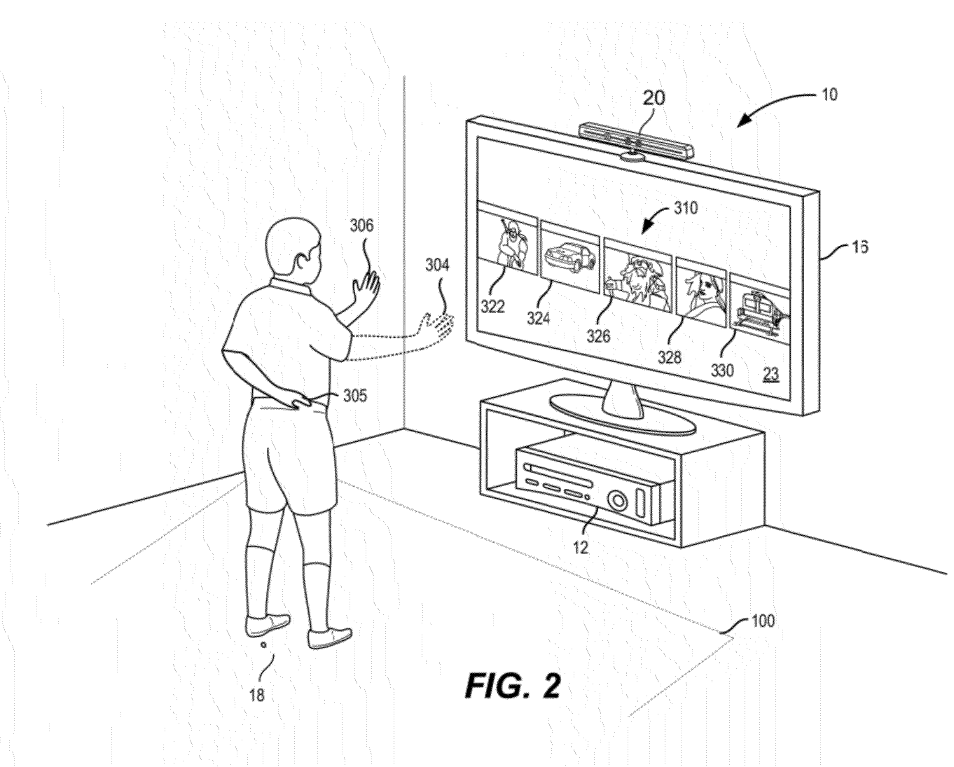

FIGS. 1 and 2 illustrate one embodiment of a target recognition, analysis and tracking system 10 (generally referred to as a tracking system hereinafter) with a user 18 interacting with a system user-interface 23. The target recognition, analysis and tracking system 10 may be used to recognize, analyze, and/or track a human target such as the user 18, and provide a human controlled interface.

As shown in FIG. 1, the tracking system 10 may include a computing environment 12. The computing environment 12 may be a computer, a gaming system or console, or the like. According to one embodiment, the computing environment 12 may include hardware components and/or software components such that the computing environment 12 may be used to execute an operating system and applications such as gaming applications, non-gaming applications, or the like. In one embodiment, computing system 12 may include a processor such as a standardized processor, a specialized processor, a microprocessor, or the like that may execute instructions stored on a processor readable storage device for performing the processes described herein.

As shown in FIGS. 1 and 2, the tracking system 10 may further include a capture device 20. The capture device 20 may be, for example, a camera that may be used to visually monitor one or more users, such as the user 18, such that gestures performed by the one or more users may be captured, analyzed, and tracked to perform one or more controls or actions for the user-interface of an operating system or application.

The capture device may be positioned on a three-axis positioning motor allowing the capture device to move relative to a base element on which it is mounted.

According to one embodiment, the tracking system 10 may be connected to an audiovisual device 16 such as a television, a monitor, a high-definition television (HDTV), or the like that may provide game or application visuals and/or audio to a user such as the user 18. For example, the computing environment 12 may include a video adapter such as a graphics card and/or an audio adapter such as a sound card that may provide audiovisual signals associated with the game application, non-game application, or the like. The audiovisual device 16 may receive the audiovisual signals from the computing environment 12 and may output the game or application visuals and/or audio associated with the audiovisual signals to the user 18. According to one embodiment, the audiovisual device 16 may be connected to the computing environment 12 via, for example, an S-Video cable, a coaxial cable, an HDMI cable, a DVI cable, a VGA cable, or the like.

As shown in FIGS. 1 and 2, the target recognition, analysis and tracking system 10 may be used to recognize, analyze, and/or track one or more human targets such as the user 18. For example, the user 18 may be tracked using the capture device 20 such that the movements of user 18 may be interpreted as controls that may be used to affect an application or operating system being executed by computer environment 12.

Consider a gaming application such as a boxing game executing on the computing environment 12. The computing environment 12 may use the audiovisual device 16 to provide a visual representation of a boxing opponent to the user 18 and the audiovisual device 16 to provide a visual representation of a player avatar that the user 18 may control with his or her movements. The user 18 may make movements (e.g., throwing a punch) in physical space to cause the player avatar to make a corresponding movement in game space. Movements of the user may be recognized and analyzed in physical space such that corresponding movements for game control of the player avatar in game space are performed.

Some movements may be interpreted as controls that may correspond to actions other than controlling a player avatar or other gaming object. For example, the player may use movements to end, pause, or save a game, select a level, view high scores, communicate with a friend, etc. Virtually any controllable aspect of an operating system and/or application may be controlled by movements of the target such as the user 18. The player may use movements to select a game or other application from a main user interface. A full range of motion of the user 18 may be available, used, and analyzed in any suitable manner to interact with an application or operating system.

In FIGS. 1-2 user 18 is interacting with the tracking system 10 to control the system user-interface (UI) 23, which in this particular example is displaying a list 310 of menu items 320-330. The individual items may represent applications or other UI objects. A user may scroll left or right (as seen from the user's point of view) through the list 310 to view other menu items not in the current display but also associated with the list, select menu items to trigger an action such as opening an application represented by the menu item or further UI controls for that item. The user may also move backwards through the UI to a higher level menu item in the UI hierarchy.

The system may include gesture recognition, so that a user may control an application or operating system executing on the computing environment 12, which as discussed above may be a game console, a computer, or the like, by performing one or more gestures. In one embodiment, a gesture recognizer engine, the architecture of which is described more fully below, is used to determine from a skeletal model of a user when a particular gesture has been made by the user.

Generally, as indicated in FIGS. 1 and 2, a user 18 is confined to a physical space 100 when using a capture device 20. The physically limited space 100 is generally the best performing range of the capture device 20.

The virtual object navigation system may utilize a body part tracking system that uses the position of some body parts such as the head, shoulders, hip center, knees, ankles, etc. to calculate some derived quantities, and then uses these quantities to calculate the camera position of the virtual observer continuously (i.e. frame-over-frame) in real time in an analog manner rather than digital (i.e. subtle movements of the user result in subtle movements of the camera, so that rather than simple left/right movement the user may move the camera slowly or quickly with precision left/right, or in any other direction).

For instance, various motions of the hands or other body parts may correspond to common system wide tasks such as to navigate up or down in a hierarchical menu structure, scroll items in a menu list, open a file, close a file, and save a file. Gestures may also be used in a video-game-specific context, depending on the game. For instance, with a driving game, various motions of the hands and feet may correspond to steering a vehicle in a direction, shifting gears, accelerating, and braking.

In FIGS. 1-2, the user performs a right-handed gesture to scroll the list of menu items to the left as seen from the user's point of view. The user begins with his right hand in position 304 as shown in FIG. 1, then moves it to position 306 toward the left side of his body. The list 310 of menu items 320-328 is in a first position in FIG. 1 when the user begins the gesture with his hand at position 304. In FIG. 2, the user has moved his hand to position 306, causing the list of menu items to change by scrolling the list 310 of menu items to the left. Menu item 320 has been removed from the list as a result of scrolling to the left (as defined in user's 18 point of view). Each of items 322-328 has moved one place to the left, replacing the position of the immediately preceding item. Item 330 has been added to the list, as a result of scrolling from the right to the left.

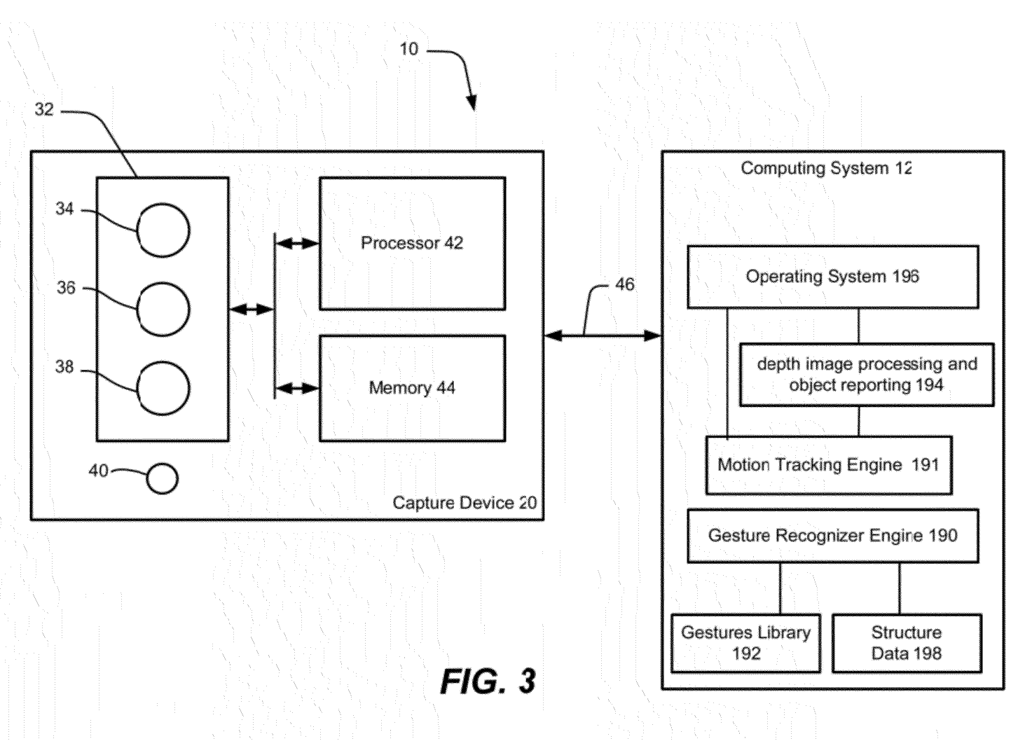

FIG. 3 illustrates one embodiment of a capture device 20 and computing system 12 that may be used in the target recognition, analysis and tracking system 10 to recognize human and non-human targets in a capture area of limited space 100 (without special sensing devices attached to the subjects), uniquely identify them and track them in three dimensional space. According to one embodiment, the capture device 20 may be configured to capture video with depth information including a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z-axis extending from the depth camera along its line of sight.

As shown in FIG. 3, the capture device 20 may include an image camera component 32. According to one embodiment, the image camera component 32 may be a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

As shown in FIG. 3, the image camera component 32 may include an IR light component 34, a three-dimensional (3-D) camera 36, and an RGB camera 38 that may be used to capture the depth image of a capture area. For example, in time-of-flight analysis, the IR light component 34 of the capture device 20 may emit an infrared light onto the capture area and may then use sensors to detect the backscattered light from the surface of one or more targets and objects in the capture area using, for example, the 3-D camera 36 and/or the RGB camera 38. In some embodiments, pulsed infrared light may be used such that the time between an outgoing light pulse and a corresponding incoming light pulse may be measured and used to determine a physical distance from the capture device 20 to a particular location on the targets or objects in the capture area. Additionally, the phase of the outgoing light wave may be compared to the phase of the incoming light wave to determine a phase shift. The phase shift may then be used to determine a physical distance from the capture device to a particular location on the targets or objects.

According to one embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example, the capture device 20 may use structured light to capture depth information. In such an analysis, patterned light (i.e., light displayed as a known pattern such as grid pattern or a stripe pattern) may be projected onto the capture area via, for example, the IR light component 34. Upon striking the surface of one or more targets or objects in the capture area, the pattern may become deformed in response. Such a deformation of the pattern may be captured by, for example, the 3-D camera 36 and/or the RGB camera 38 and may then be analyzed to determine a physical distance from the capture device to a particular location on the targets or objects.

According to one embodiment, the capture device 20 may include two or more physically separated cameras that may view a capture area from different angles, to obtain visual stereo data that may be resolved to generate depth information. Other types of depth image sensors can also be used to create a depth image.

The capture device 20 may further include a microphone 40. The microphone 40 may include a transducer or sensor that may receive and convert sound into an electrical signal. According to one embodiment, the microphone 40 may be used to reduce feedback between the capture device 20 and the computing environment 12 in the target recognition, analysis and tracking system 10. Additionally, the microphone 40 may be used to receive audio signals that may also be provided by the user to control applications such as game applications, non-game applications, or the like that may be executed by the computing environment 12.

In one embodiment, the capture device 20 may further include a processor 42 that may be in operative communication with the image camera component 32. The processor 42 may include a standardized processor, a specialized processor, a microprocessor, or the like that may execute instructions that may include instructions for storing profiles, receiving the depth image, determining whether a suitable target may be included in the depth image, converting the suitable target into a skeletal representation or model of the target, or any other suitable instruction.

The capture device 20 may further include a memory component 44 that may store the instructions that may be executed by the processor 42, images or frames of images captured by the 3-D camera or RGB camera, user profiles or any other suitable information, images, or the like. According to one example, the memory component 44 may include random access memory (RAM), read only memory (ROM), cache, Flash memory, a hard disk, or any other suitable storage component. As shown in FIG. 3, the memory component 44 may be a separate component in communication with the image capture component 32 and the processor 42. In another embodiment, the memory component 44 may be integrated into the processor 42 and/or the image capture component 32. In one embodiment, some or all of the components 32, 34, 36, 38, 40, 42 and 44 of the capture device 20 illustrated in FIG. 2 are housed in a single housing.

The capture device 20 may be in communication with the computing environment 12 via a communication link 46. The communication link 46 may be a wired connection including, for example, a USB connection, a Firewire connection, an Ethernet cable connection, or the like and/or a wireless connection such as a wireless 802.11b, g, a, or n connection. The computing environment 12 may provide a clock to the capture device 20 that may be used to determine when to capture, for example, a scene via the communication link 46.

The capture device 20 may provide the depth information and images captured by, for example, the 3-D camera 36 and/or the RGB camera 38, including a skeletal model that may be generated by the capture device 20, to the computing environment 12 via the communication link 46. The computing environment 12 may then use the skeletal model, depth information, and captured images to, for example, create a virtual screen, adapt the user interface and control an application such as a game or word processor.

A motion tracking system 191 uses the skeletal model and the depth information to provide a control output to an application on a processing device to which the capture device 20 is coupled. The depth information may likewise be used by a gestures library 192, structure data 198, gesture recognition engine 190, depth image processing and object reporting module 194 and operating system 196. Depth image processing and object reporting module 194 uses the depth images to track motion of objects, such as the user and other objects. The depth image processing and object reporting module 194 will report to operating system 196 an identification of each object detected and the location of the object for each frame. Operating system 196 will use that information to update the position or movement of an avatar or other images in the display or to perform an action on the provided user-interface. To assist in the tracking of the objects, depth image processing and object reporting module 194 uses gestures library 190, structure data 198 and gesture recognition engine 190.

Structure data 198 includes structural information about objects that may be tracked. For example, a skeletal model of a human may be stored to help understand movements of the user and recognize body parts. Structural information about inanimate objects may also be stored to help recognize those objects and help understand movement.

Gestures library 192 may include a collection of gesture filters, each comprising information concerning a gesture that may be performed by the skeletal model (as the user moves). A gesture recognition engine 190 may compare the data captured by the cameras 36, 38 and device 20 in the form of the skeletal model and movements associated with it to the gesture filters in the gesture library 192 to identify when a user (as represented by the skeletal model) has performed one or more gestures. Those gestures may be associated with various controls of an application. Thus, the computing system 12 may use the gestures library 190 to interpret movements of the skeletal model and to control operating system 196 or an application (not shown) based on the movements.

More information about recognizer engine 190 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009, both of which are incorporated by reference herein in their entirety. More information about motion detection and tracking can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety.

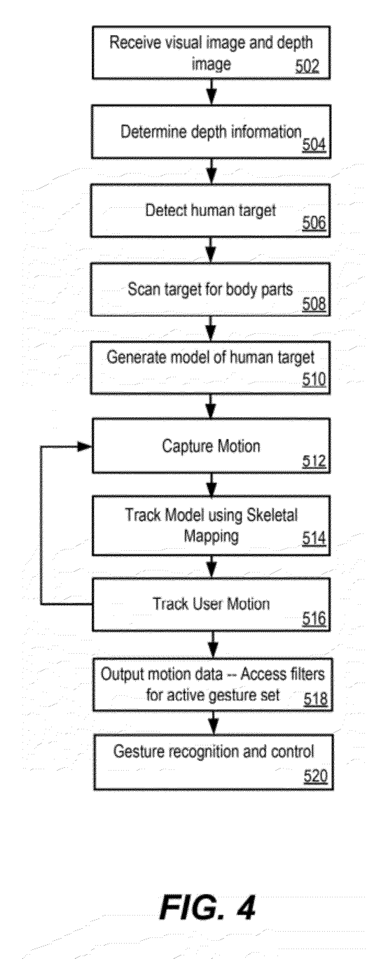

FIG. 4 is a flowchart describing one embodiment of a process for gesture control of a user interface as can be performed by tracking system 10 in one embodiment. At step 502, processor 42 of the capture device 20 receives a visual image and depth image from the image capture component 32. In other examples, only a depth image is received at step 502. The depth image and visual image can be captured by any of the sensors in image capture component 32 or other suitable sensors as are known in the art. In one embodiment the depth image is captured separately from the visual image. In some implementations the depth image and visual image are captured at the same time while in others they are captured sequentially or at different times. In other embodiments the depth image is captured with the visual image or combined with the visual image as one image file so that each pixel has an R value, a G value, a B value and a Z value (representing distance).

At step 504 depth information corresponding to the visual image and depth image are determined. The visual image and depth image received at step 502 can be analyzed to determine depth values for one or more targets within the image. Capture device 20 may capture or observe a capture area that may include one or more targets. At step 506, the capture device determines whether the depth image includes a human target. In one example, each target in the depth image may be flood filled and compared to a pattern to determine whether the depth image includes a human target. In one example, the edges of each target in the captured scene of the depth image may be determined The depth image may include a two dimensional pixel area of the captured scene for which each pixel in the 2D pixel area may represent a depth value such as a length or distance for example as can be measured from the camera. The edges may be determined by comparing various depth values associated with for example adjacent or nearby pixels of the depth image. If the various depth values being compared are greater than a pre-determined edge tolerance, the pixels may define an edge. The capture device may organize the calculated depth information including the depth image into Z layers or layers that may be perpendicular to a Z-axis extending from the camera along its line of sight to the viewer. The likely Z values of the Z layers may be flood filled based on the determined edges. For instance, the pixels associated with the determined edges and the pixels of the area within the determined edges may be associated with each other to define a target or a physical object in the capture area.

At step 508, the capture device scans the human target for one or more body parts. The human target can be scanned to provide measurements such as length, width or the like that are associated with one or more body parts of a user, such that an accurate model of the user may be generated based on these measurements. In one example, the human target is isolated and a bit mask is created to scan for the one or more body parts. The bit mask may be created for example by flood filling the human target such that the human target is separated from other targets or objects in the capture area elements. At step 510 a model of the human target is generated based on the scan performed at step 508. The bit mask may be analyzed for the one or more body parts to generate a model such as a skeletal model, a mesh human model or the like of the human target. For example, measurement values determined by the scanned bit mask may be used to define one or more joints in the skeletal model. The bitmask may include values of the human target along an X, Y and Z-axis. The one or more joints may be used to define one or more bones that may correspond to a body part of the human.

According to one embodiment, to determine the location of the neck, shoulders, or the like of the human target, a width of the bitmask, for example, at a position being scanned, may be compared to a threshold value of a typical width associated with, for example, a neck, shoulders, or the like. In an alternative embodiment, the distance from a previous position scanned and associated with a body part in a bitmask may be used to determine the location of the neck, shoulders or the like.

In one embodiment, to determine the location of the shoulders, the width of the bitmask at the shoulder position may be compared to a threshold shoulder value. For example, a distance between the two outer most Y values at the X value of the bitmask at the shoulder position may be compared to the threshold shoulder value of a typical distance between, for example, shoulders of a human. Thus, according to an example embodiment, the threshold shoulder value may be a typical width or range of widths associated with shoulders of a body model of a human.

In another embodiment, to determine the location of the shoulders, the bitmask may be parsed downward a certain distance from the head. For example, the top of the bitmask that may be associated with the top of the head may have an X value associated therewith. A stored value associated with the typical distance from the top of the head to the top of the shoulders of a human body may then added to the X value of the top of the head to determine the X value of the shoulders. Thus, in one embodiment, a stored value may be added to the X value associated with the top of the head to determine the X value associated with the shoulders.

In one embodiment, some body parts such as legs, feet, or the like may be calculated based on, for example, the location of other body parts. For example, as described above, the information such as the bits, pixels, or the like associated with the human target may be scanned to determine the locations of various body parts of the human target. Based on such locations, subsequent body parts such as legs, feet, or the like may then be calculated for the human target.

According to one embodiment, upon determining the values of, for example, a body part, a data structure may be created that may include measurement values such as length, width, or the like of the body part associated with the scan of the bitmask of the human target. In one embodiment, the data structure may include scan results averaged from a plurality depth images. For example, the capture device may capture a capture area in frames, each including a depth image. The depth image of each frame may be analyzed to determine whether a human target may be included as described above. If the depth image of a frame includes a human target, a bitmask of the human target of the depth image associated with the frame may be scanned for one or more body parts. The determined value of a body part for each frame may then be averaged such that the data structure may include average measurement values such as length, width, or the like of the body part associated with the scans of each frame. In one embodiment, the measurement values of the determined body parts may be adjusted such as scaled up, scaled down, or the like such that measurement values in the data structure more closely correspond to a typical model of a human body. Measurement values determined by the scanned bitmask may be used to define one or more joints in a skeletal model at step 510.

At step 512, motion is captured from the depth images and visual images received from the capture device. In one embodiment capturing motion at step 514 includes generating a motion capture file based on the skeletal mapping as will be described in more detail hereinafter. At 514, the model created in step 510 is tracked using skeletal mapping and to track user motion at 516. For example, the skeletal model of the user 18 may be adjusted and updated as the user moves in physical space in front of the camera within the field of view. Information from the capture device may be used to adjust the model so that the skeletal model accurately represents the user. In one example this is accomplished by one or more forces applied to one or more force receiving aspects of the skeletal model to adjust the skeletal model into a pose that more closely corresponds to the pose of the human target and physical space.

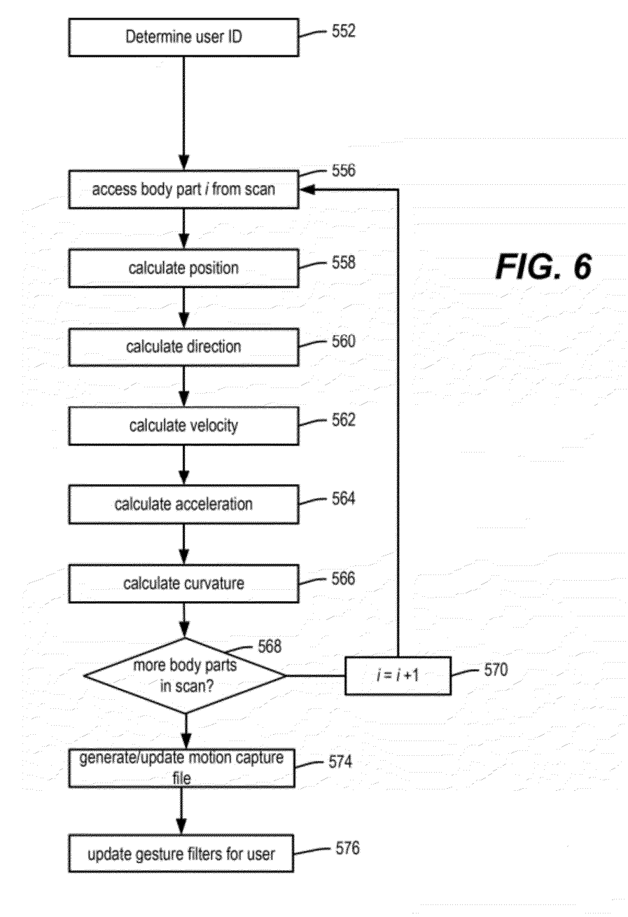

At step 516 user motion is tracked. An example of tracking user motion is discussed with respect to FIG. 6.

At step 518 motion data is provided to an application, such as a navigation system as described herein. Such motion data may further be evaluated to determine whether a user is performing a pre-defined gesture. Step 518 can be performed based on the UI context or contexts determined in step 516. For example, a first set of gestures may be active when operating in a menu context while a different set of gestures may be active while operating in a game play context. Step 518 can also include determining an active set of gestures. At step 520 gesture recognition and control is performed. The tracking model and captured motion are passed through the filters for the active gesture set to determine whether any active gesture filters are satisfied. Any detected gestures are applied within the computing environment to control the user interface provided by computing environment 12. Step 520 can further include determining whether any gestures are present and if so, modifying the user-interface action that is performed in response to gesture detection.

In one embodiment, steps 516-520 are performed by computing device 12. Furthermore, although steps 502-514 are described as being performed by capture device 20, various ones of these steps may be performed by other components, such as by computing environment 12. For example, the capture device 20 may provide the visual and/or depth images to the computing environment 12 which will in turn, determine depth information, detect the human target, scan the target, generate and track the model and capture motion of the human target.

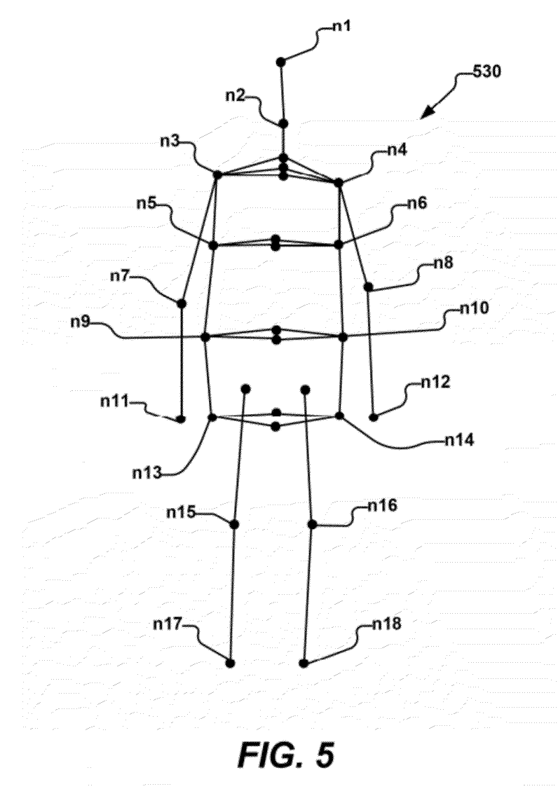

FIG. 5 illustrates an example of a skeletal model or mapping 530 representing a scanned human target that may be generated at step 510 of FIG. 4. According to one embodiment, the skeletal model 530 may include one or more data structures that may represent a human target as a three-dimensional model. Each body part may be characterized as a mathematical vector defining joints and bones of the skeletal model 530.

Skeletal model 530 includes joints n1-n18. Each of the joints n1-n18 may enable one or more body parts defined there between to move relative to one or more other body parts. A model representing a human target may include a plurality of rigid and/or deformable body parts that may be defined by one or more structural members such as “bones” with the joints n1-n18 located at the intersection of adjacent bones. The joints n1-n18 may enable various body parts associated with the bones and joints n1-n18 to move independently of each other or relative to each other. For example, the bone defined between the joints n7 and n11 corresponds to a forearm that may be moved independent of, for example, the bone defined between joints n15 and n17 that corresponds to a calf. It is to be understood that some bones may correspond to anatomical bones in a human target and/or some bones may not have corresponding anatomical bones in the human target.

The bones and joints may collectively make up a skeletal model, which may be a constituent element of the model. An axial roll angle may be used to define a rotational orientation of a limb relative to its parent limb and/or the torso. For example, if a skeletal model is illustrating an axial rotation of an arm, a roll joint may be used to indicate the direction the associated wrist is pointing (e.g., palm facing up). By examining an orientation of a limb relative to its parent limb and/or the torso, an axial roll angle may be determined. For example, if examining a lower leg, the orientation of the lower leg relative to the associated upper leg and hips may be examined in order to determine an axial roll angle.

FIG. 6 is a flowchart describing one embodiment of a process for capturing motion using one or more capture devices including depth cameras, and tracking a target within the capture device's field of view for controlling a user interface. FIG. 6 provides more detail for tracking a model and capturing motion as performed at steps 512 and 514 of FIG. 5 in one example.

At step 552 a user identity of a human target in the field of view may be determined Step 552 is optional. In one example, step 552 can use facial recognition to correlate the user's face from a received visual image with a reference visual image. In another example, determining the user I.D. can include receiving input from the user identifying their I.D. For example, a user profile may be stored by computer environment 12 and the user may make an on screen selection to identify themselves as corresponding to that user profile. Other examples for determining an I.D. of a user can be used.

To track the user's motion, skeletal mapping of the target's body parts is utilized. At step 556 a body part i resulting from scanning the human target and generating a model at steps 508 and 510 is accessed. At step 558 the position of the body part is calculated in X, Y, Z space to create a three dimensional positional representation of the body part within the field of view of the camera. At step 560 a direction of movement of the body part is calculated, dependent upon the position. The directional movement may have components in any one of or a combination of the X, Y, and Z directions. In step 562 the body part's velocity of movement is determined. At step 564 the body parts acceleration is calculated. At step 566 the curvature of the body parts movement in the X, Y, Z space is determined, for example, to represent non-linear movement within the capture area by the body part. The velocity, acceleration and curvature calculations are not dependent upon the direction. It is noted that steps 558 through 566 are but an example of calculations that may be performed for skeletal mapping of the user's movement. In other embodiments, additional calculations may be performed or less than all of the calculations illustrated in FIG. 6 can be performed. In step 568 the tracking system determines whether there are more body parts identified by the scan at step 508. If there are additional body parts in the scan, i is set to i+1 at step 570 and the method returns to step 556 to access the next body part from the scanned image. The use of X, Y, Z Cartesian mapping is provided only as an example. In other embodiments, different coordinate mapping systems can be used to calculate movement, velocity and acceleration. A spherical coordinate mapping, for example, may be useful when examining the movement of body parts which naturally rotate around joints.

Once all body parts in the scan have been analyzed as determined at step 570, a motion capture file is generated or updated for the target at step 574. The target recognition analysis and tracking system may render and store a motion capture file that can include one or more motions such as a gesture motion. In one example, the motion capture file is generated in real time based on information associated with the tracked model. For example, in one embodiment the motion capture file may include the vectors including X, Y, and Z values that define the joints and bones of the model as it is being tracked at various points in time. As described above, the model being tracked may be adjusted based on user motions at various points in time and a motion capture file of the model for the motion may be generated and stored. The motion capture file may capture the tracked model during natural movement by the user interacting with the target recognition analysis and tracking system. For example, the motion capture file may be generated such that the motion capture file may naturally capture any movement or motion by the user during interaction with the target recognition analysis and tracking system. The motion capture file may include frames corresponding to, for example, a snapshot of the motion of the user at different points in time. Upon capturing the tracked model, information associated with the model including any movements or adjustment applied thereto at a particular point in time may be rendered in a frame of the motion capture file. The information in the frame may include for example the vectors including the X, Y, and Z values that define the joints and bones of the tracked model and a time stamp that may be indicative of a point in time in which for example the user performed the movement corresponding to the pose of the tracked model.

In step 576 the system adjusts the gesture settings for the particular user being tracked and modeled, if warranted. The gesture settings can be adjusted based on the information determined at steps 552 and 554 as well as the information obtained for the body parts and skeletal mapping performed at steps 556 through 566. In one particular example, if a user is having difficulty completing one or more gestures, the system can recognize this for example, by parameters nearing but not meeting the threshold requirements for the gesture recognition. In such a case, adjusting the gesture settings can include relaxing the constraints for performing the gesture as identified in one or more gesture filters for the particular gesture. Similarly, if a user demonstrates a high level of skill, the gesture filters may be adjusted to constrain the movement to more precise renditions so that false positives can be avoided. In other words, by tightening the constraints of a skilled user, it will be less likely that the system will misidentify a movement as a gesture when no gesture was intended.

The system may apply pre-determined actions to the user-interface based on one or more motions of the tracked model that satisfy one or more gesture filters. The joints and bones in the model captured in the motion capture file may be mapped to particular portions of the game character or avatar. For example, the joint associated with the right elbow may be mapped to the right elbow of the avatar or game character. The right elbow may then be animated to mimic the motions of the right elbow associated with the model of the user in each frame of the motion capture file, or the right elbow's movement may be passed to a gesture filter to determine if the corresponding constraints have been satisfied.

According to one example, the tracking system may apply the one or more motions as the motions are captured in the motion capture file. Thus, when a frame is rendered in the motion capture file, the motions captured in the frame may be applied to the avatar, game character or user-interface such that the avatar or game character may be animated to immediately mimic the motions captured in the frame. Similarly, the system may apply the UI actions as the motions are determined to satisfy one or more gesture filters.

In another embodiment, the tracking system may apply the one or more motions after the motions are captured in a motion capture file. For example, a motion such as a walking motion or a motion such as a press or fling gesture, described below, may be performed by the user and captured and stored in the motion capture file. The motion may then be applied to the avatar, game character or user interface each time, for example, the user subsequently performs a gesture recognized as a control associated with the motion such as the walking motion or press gesture.

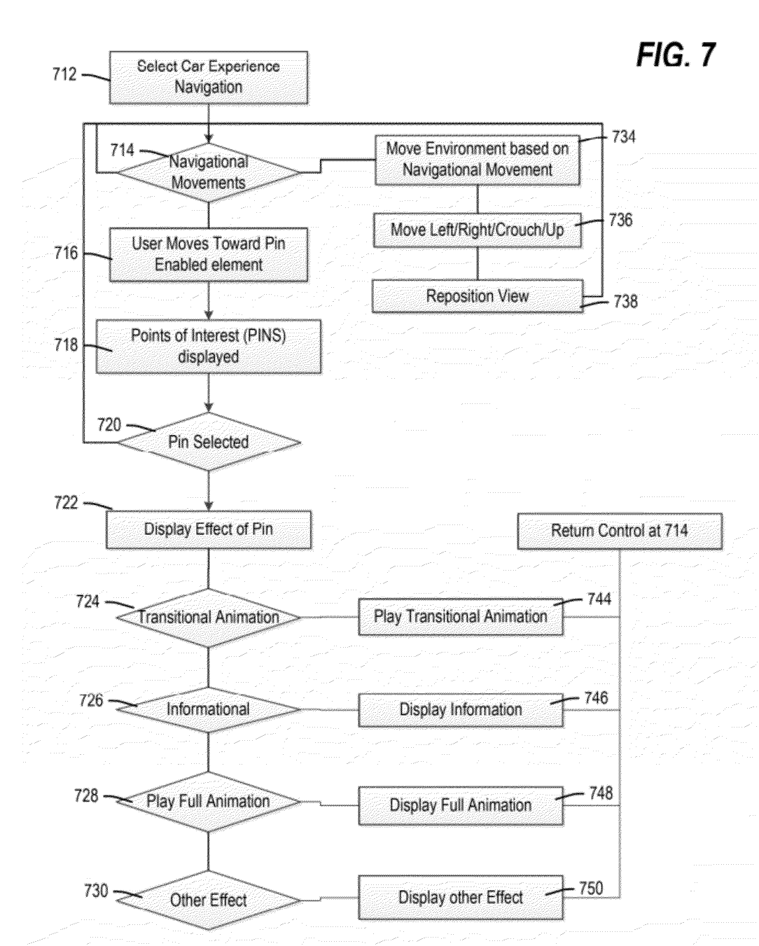

FIG. 7 is a flowchart depicting a first navigation sequence in accordance with the present technology. In FIG. 7, the technology will be described in relation to navigation using a recognition system wherein a user in a confined physical space wishes to navigate around a virtually rendered vehicle.

At 712, a user may use the user interface and gestures described with respect to FIGS. 1 and 2 to navigate through an application to a virtual navigation experience. Navigation to the virtual vehicle experience can include, but not be limited to selecting the experience in a game menu providing other entertainment sequences using the vehicles, such as an opportunity to race the vehicles, modify the vehicles, record a user's racing activity with the vehicles, play other users activity with the vehicles, and the like. The selection at 712 may include a particular vehicle that the user wishes to explore.

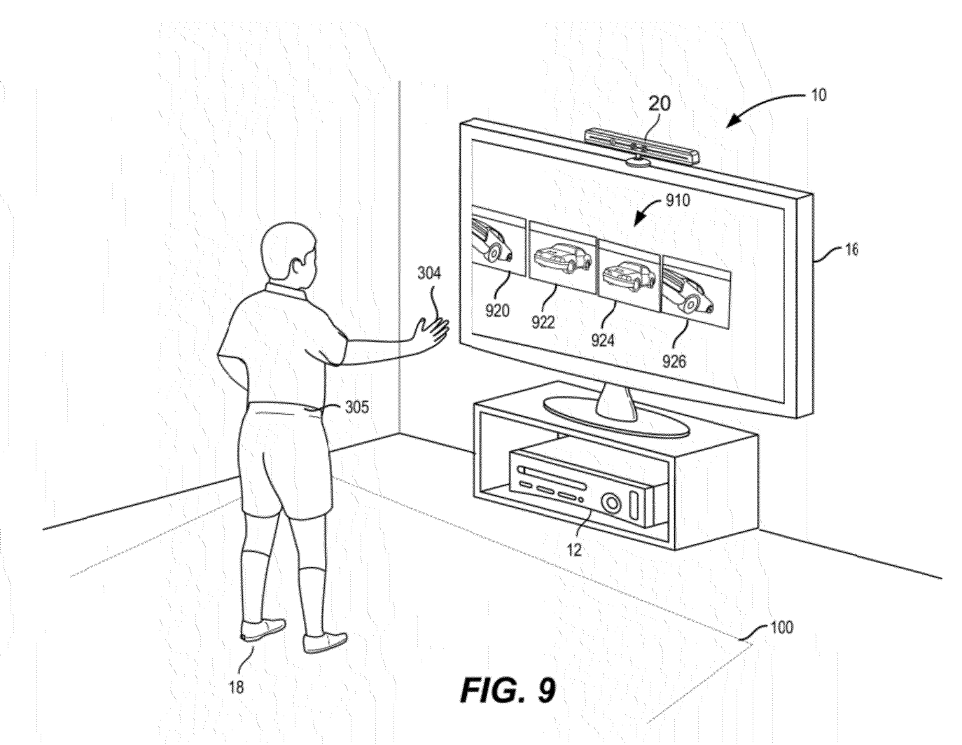

Selection step 712 is illustrated in FIG. 9 where a user 18 uses interface 910 to select from a plurality of vehicles 920, 922, 924, 926, which the user may wish to explore in further detail. The user is positioned within a limited for the user to explore.

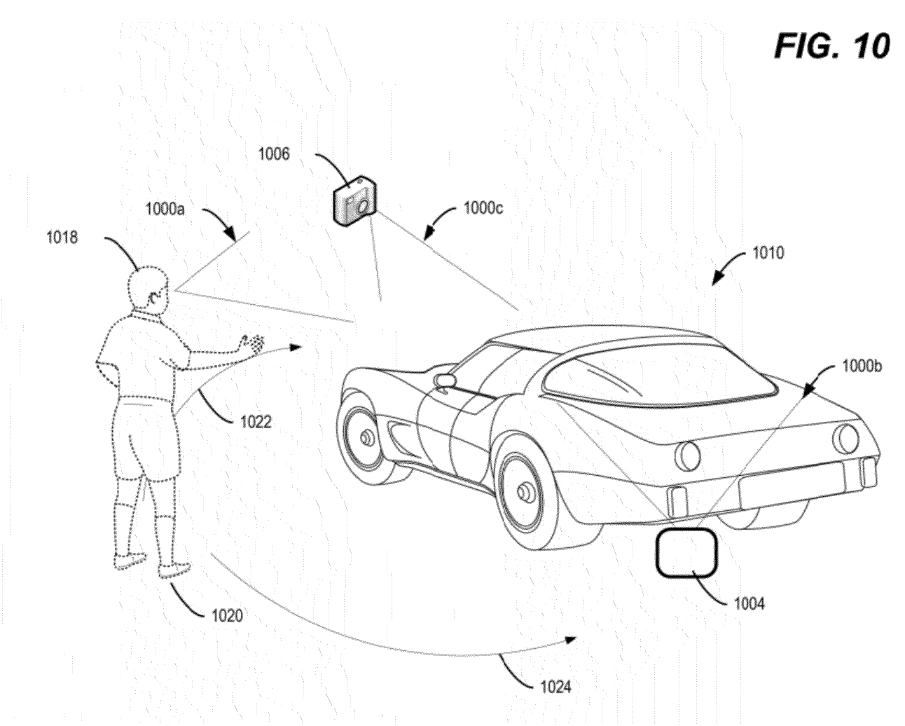

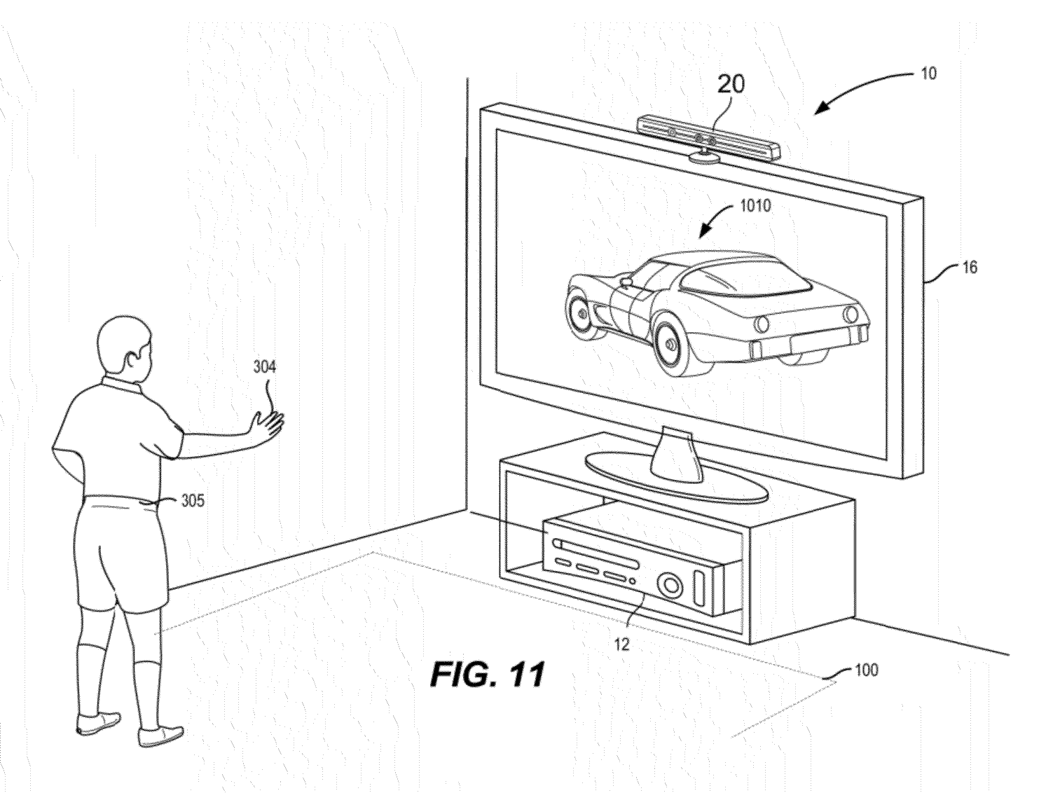

FIG. 10 illustrates a number of virtual perspectives of physical space 100. Once the user has selected a vehicle, the user will be presented with a detailed view of the vehicle from a perspective illustrated in FIG. 10. Once the user has selected a vehicle in the virtual environment, the vehicle may be rendered in the virtual environment a virtual user 1018 relative to a virtual, three dimensional vehicle. Vehicle 1010 is rendered in a virtual environment of which the user may have a nearly infinite number of perspectives. It will be understood that the virtual representation of the user 1018, in one embodiment, is not shown in the screen representation of the virtual environment, as illustrated in FIGS. 11-16. The representation 1018 is provided for understanding of the real and virtual user's perspective. For example, a user viewing a virtual vehicle 1010 will have a first perspective and first field of view 100a when the user is standing in a position represented at 1020, at the side of the vehicle. As the user walked to the right, around the vehicle as represented by arrow 1024, the user would have a second perspective and field of view 1000b. Similarly, as the user moved to the left around the vehicle, the user might have a third field of view represented by 1000c. The perspective may change both laterally and vertically, where, for example, the user crouches or moves in closer to the vehicle, as well as from side to side.

Returning to FIG. 7, at 714, the user may move relative to the capture device 20 and provide navigational movements which direct the user's virtual point of view with respect to the vehicle 1010. FIG. 11 illustrates a user 18 in conjunction with tracking system 10 as the virtual vehicle 1010 is presented on display 16.

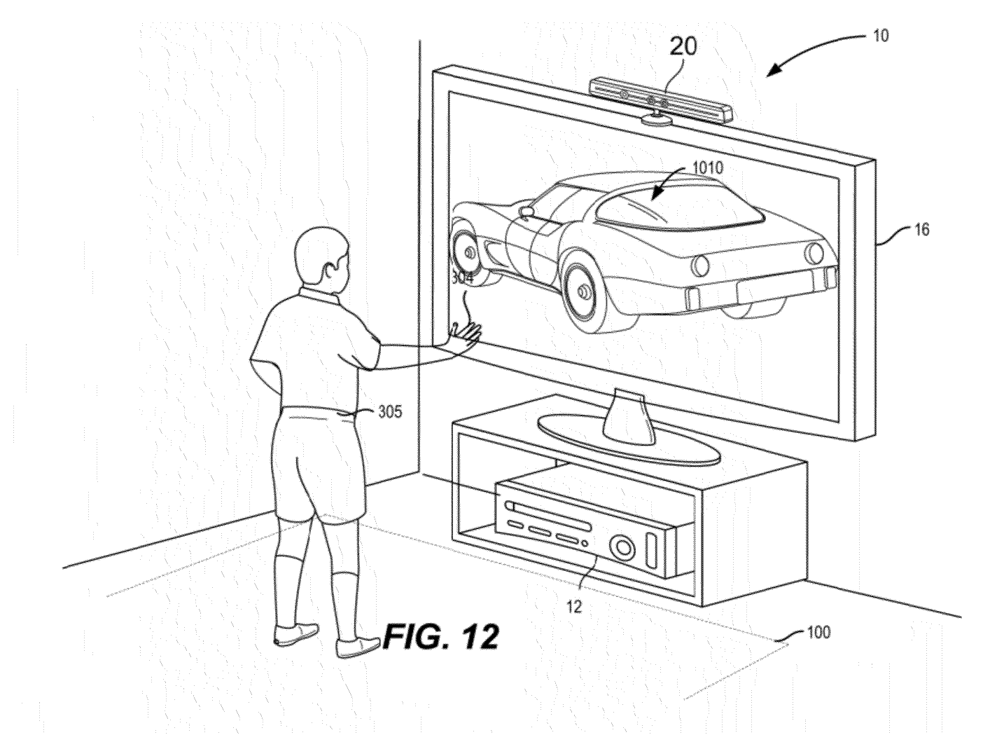

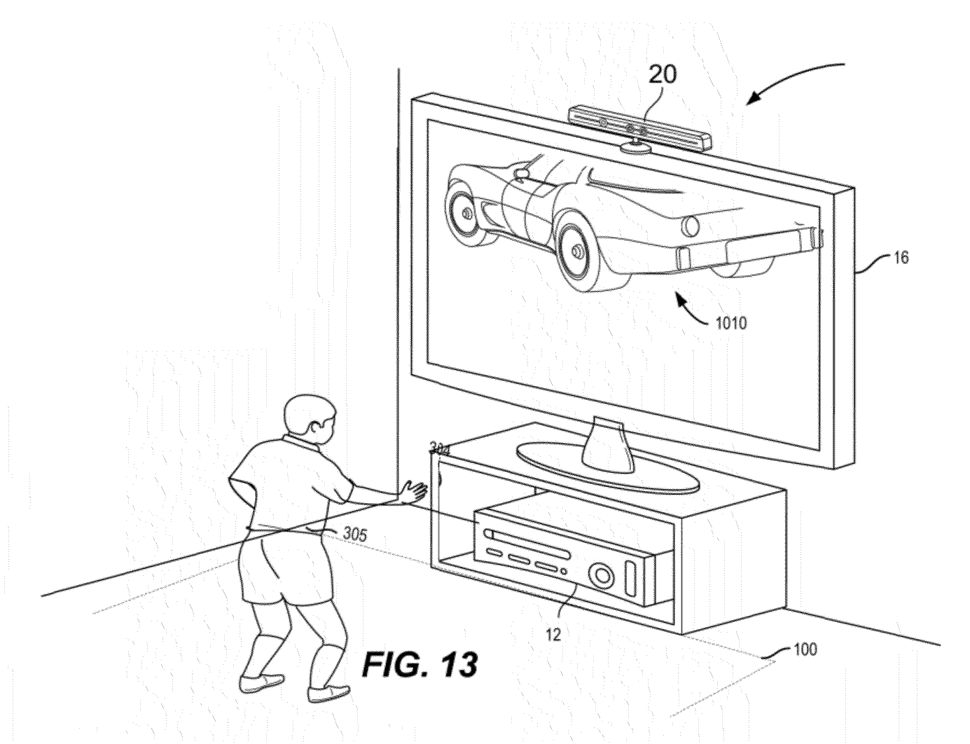

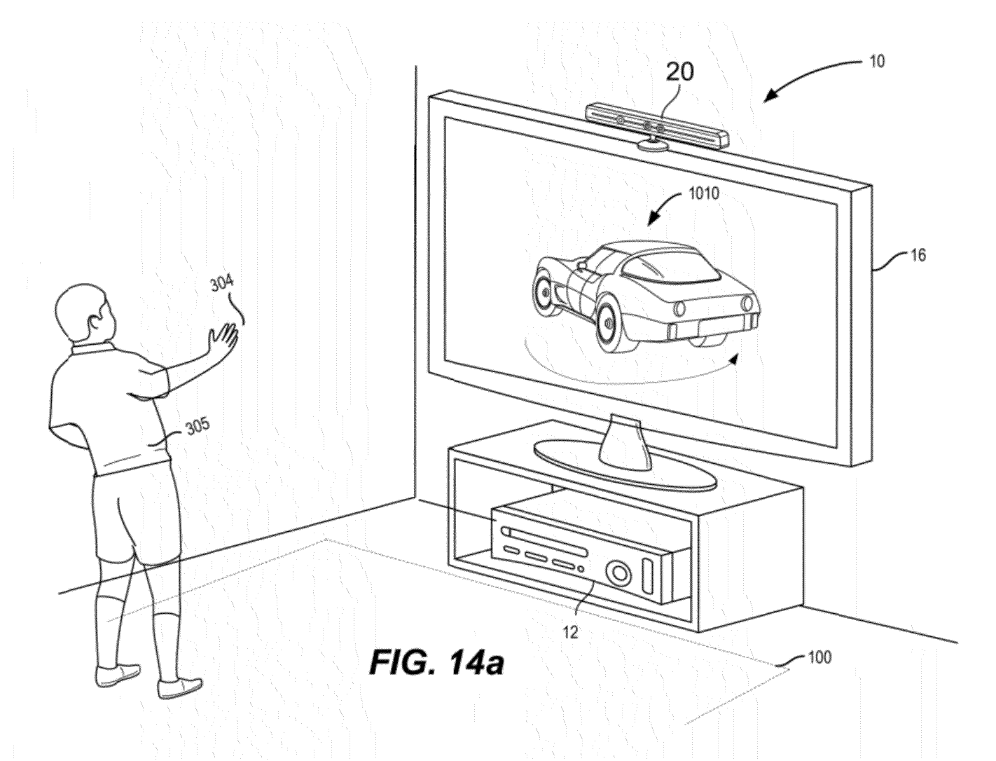

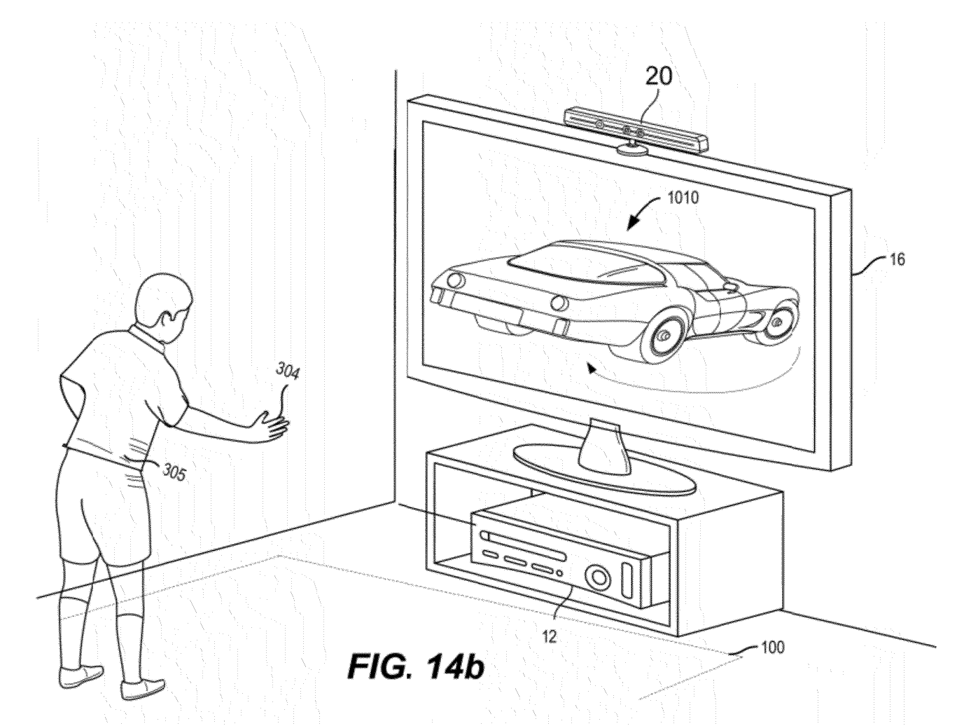

FIG. 12-14 illustrate exemplary movements of a user and the resulting view of a virtual vehicle 1010. In FIG. 12, the user moves closer to the capture device 20, with the resulting view of the vehicle 1010 being larger, as if the user were walking toward the vehicle in reality. In FIG. 13, the user is closer and in a crouched position, with the resulting view of the vehicle 1010 being from a lower perspective of the vehicle and closer than that represented in FIG. 11. FIGS. 14a and 14b illustrate a user leaning to the left, and right, respectively. A leftward lean may indicate that the user wished to move their view of the vehicle in a clockwise motion, while a right-ward lean may indicate that the user wishes to move the view in a counter-clockwise motion. A user lean is only one movement which may be translated into a movement for positioning the user. Alternative user movements may be represented as different navigational translations within the virtual environment.

Returning to FIG. 7, as the user makes navigational movements at 714, the virtual environment is moved at 734 relative to the virtual vehicle in the environment. Generally, the movements can include moving left, right, up, down in or out at 736, relative to the virtual vehicle. The view is repositioned at 738 and the system continues this loop during the exploration sequence for the vehicle.

At 716, the system constantly checks for movement of the user toward possible points of interest (POI) on the vehicle. POIs may be defined by an application developer in order to allow a user to interact with elements of the vehicle, and to focus player's attentions towards specific features of the vehicle. POI pins are placed around and throughout the vehicle. These pins point out key areas of the vehicle, are selectable and play short, entertaining, cut scenes that talk about specific areas and parts of the vehicle. Each pin has special features which were implemented and made tunable in order to help enhance the vehicle experience.

At 716, if a user moves toward a POI pin, the pins may be displayed at 718. Selecting a pin is a very simple task, requiring the player to move the cursor over the pin and then holding their hand there for a select amount of seconds. When holding the cursor over a pin, the pin plays a small canned animation of some kind of meter within the pin's icon filling up. This meter fills depending on the amount of time it takes to activate the pin.

In order to allow a user to interact with elements of the vehicle, and to focus players' attentions towards specific features of the vehicle, P.O.I. pins are placed around and throughout the vehicle. These pins point out key areas of the vehicle, are selectable and provide additional information or play short, entertaining, cut scenes that talk about specific areas and parts of the vehicle. Each pin has special features which were implemented and made tunable in order to help enhance the vehicle experience.

In a human controlled user interface, selecting a pin may be as easy as a user moving the cursor over the pin and then holding their hand there for a select amount of seconds. When holding the cursor over a pin, the pin plays a small canned animation of some kind of meter within the pin's icon filling up. This meter fills depending on the amount of time it takes to activate the pin. Each pin has its own field of view, which is an invisible cone that protrudes out from the pin. Whenever players are inside this cone, the pin becomes visible and selectable. Whenever they leave the cone field of view, the pin disappears. Distance fading makes each pin fade to transparent when players get further away from them. This prevents pins popping in and out of view whenever players enter and exit each pin's field of view cone.

In one embodiment, the interface presents faded views of other pins so that players are intuitively guided to each pin because they can faintly see other pins around the vehicle from their perspective within the game. This may entice the user to move toward the pin in order to select it.

An animation mode of interacting with some of the POIs is provided. Interaction may include POIs that animate some change in state of the viewed object (e.g. the vehicle) such as opening a door, trunk, hood, cargo compartment, or the like, or moving some other movable part of the object such as an adjustable spoiler, that allows the user to first select the POI by positioning the cursor via hand movement, then hovering briefly over the POI, or, alternatively, the POI may be immediately selected when the cursor is positioned over it, whereupon the interaction mode changes from using the motion of the hand projected to a 2D space to control 2D cursor movement on the screen to using the motion of the hand in full 3D to control a 3D interaction with a predetermined path of movement that approximates via some simple parameterized space curve such as a line segment, arc, section of a quadratic or cubic curve or spiral, or the like, the progress of that animation, the path and progress along the path being determined by some like interaction enabling the user to move their hand in 3D along a path that maps the viewed space curve into the user's body space to advance and reverse the animation, and the path being rendered in 3D as a 2D overlay or 3D object within the world accompanied by a marker indicating the progress along this path, the marker in some cases being mapped to correlate with a point on a portion of the viewed object that follows the parameterized space curve as the animation progresses, and the interaction mode completing when some specified endpoint is reached in the animation progress, or the hand is dropped to cancel the animation, or by some other similar means, all of this being accompanied by auxiliary audio cues.

The virtual space curve displayed to the user is in the vehicle space which is transformed according to the current user virtual perspective, and the interaction path used by the user to advance and reverse the animation may also be transformed in some way to the user's body space, whether fixed to some transformation of the space curve by the initial orientation of the virtual perspective in the vehicle space or dynamically transforming as the virtual perspective moves, or may always take some fixed predetermined form in the user's body space. Furthermore, this space curve may be initially positioned in body space to begin at the point where the user's hand was when the animation interaction began and be scaled in some way so that the endpoint is within the space the user can reach by moving their hand, these values being used to scale or transform the space curve in body space as the virtual perspective orientation changes. It order to ensure that enough reach is available for a user to complete an animation interaction started from some arbitrary position on the screen resulting from the transformation of the POI in 3D onto the 2D screen, this position necessitating a specific hand position for the user relative to their body or sensor space, a number of methods may be employed, including but not limited to fading out pins in the outer extremity of the screen and disabling access to them, or initially mapping the cursor region of the screen to a region smaller than the maximum reach of the player, or this problem may not be addressed at all, relying on psychological factors naturally influencing users into positioning the POI of interest towards the center of the screen before selecting. Furthermore, anything described herein that may be based on the user's body space may also be based on 3D sensor space, rather than relative to some point on the user's body, or some combination of the two.

For example, in the game the user may “touch” via the hand cursor a POI in the vicinity of the door handle, whereupon a 3D arc comprised of arrows indicating the direction of opening and animated in some way appears overlaid on the scene, approximating the path that point on the door would take as the door is opened. This may be accompanied, for example, by a door unlatching sound if a door is being opened. The user may then move their hand roughly along the chord of this arc to advance or reverse the door opening animation in real-time, and a visual pin similar to the original selected pin accompanied by an overlaid hand cursor as well as the position of the door handle now following the path of this 3D arc is displayed to denote progress. The animation completes when the user reaches a point near the end of the chord, accompanied by an appropriate sound effect such as a door shutting sound if for example a door is being closed, or the animation may be cancelled by the user lowering their hand. If the user turns or walks around while this animation interaction is underway, the arc moves correspondingly, and the chord used for interaction moves as well to correspond to this orientation of the virtual perspective in the vehicle space.

Pins may have proximity and zones, another mechanism provided for interacting with some of the POIs, typically those that involve the user getting into the vehicle or entering an area where something may be viewed by itself in great detail, such as approaching the engine bay. In this mechanism, the activation of a POI is determined by the user's proximity to the POI, parameters being specified similar to those for the visibility cone, and possibly coinciding with them. When the user is proximal to the POI, it may change appearance or animate in some way to invite the user to step closer, and within a certain zone may begin to animate as it activates, the activation taking some number of seconds to complete, during which the user may cancel the activation by stepping out of the zone, or a larger deactivation zone specified around the activation zone. This zone may be relative to the vehicle in the vehicle space, or it may be a zone existing in the user's space, in which case it does not have to be explicitly associated with a particular POI, or it may be associated with a UI element that appears on the screen in 2D space to indicate activation progress to the user. Other than using proximity as the activation cue, these proximity pins or zones would function in a similar way to the hand cursor activated POIs already discussed, triggering animated sequences and the like.

Furthermore, activation of such proximity pins may be predicated on the user assuming a certain pose or range of poses during the activation time period, such as leaning in a general direction, or the activation time period may instead be an activation progress that is controlled by engaging in a range of poses or gesture. As an example, the user may walk up to an open vehicle door in virtual space and be expected to lean towards it to activate an animation that will carry them into the vehicle. Or once in the vehicle they may lean to one side to activate an animation that carries them out of the vehicle.

For example, in the game these proximity pins may be used to enable the user to enter the vehicle by walking up to an open door. A mode where a vehicle engine or other interesting part of the vehicle may be viewed in detail can be entered by walking up to an open engine cover, whereupon a viewing mode similar to the interior mode discussed in this document is entered enabling the user to control a more limited virtual perspective over a specified path, area, or volume with limited YAW, pitch, roll, and zoom or field of view adjustment to view this part in greater detail. The user may exit this mode by stepping back to a certain distance from the sensor, another example of proximity activation.

POIs may control the visibility of other POIs. When some POIs are activated, they may enable or disable other POIs. For example, when a door is opened, the get in vehicle proximity POI may become visible, the open door POI will become invisible, and a corresponding close door POI may become visible. These POIs may become visible or invisible to facilitate further user interaction in such a logical manner, or they may become visible or invisible for other reasons, such as to prevent POIs rendered on a 2D overlay from being visible over a part of the object being interacted with that would otherwise have occluded them were they actually present in a 3D space.

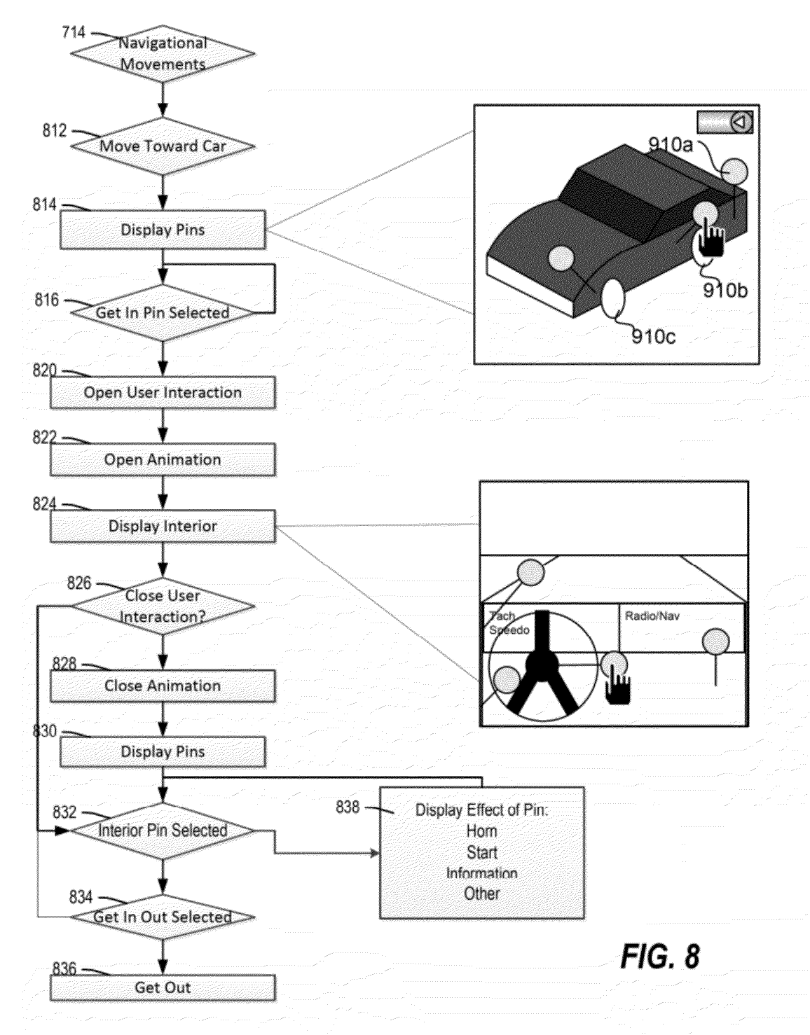

A specific example of selection of a pin is discussed below with respect to FIG. 8.

Returning to FIG. 7, once a pin is selected, at 722, the effect of the pin is performed in the interface. If the pin requires a transitional animation at 724, such as entering a vehicle or opening a hood to reveal a zoomed view of an engine, then a transitional animation is played at 744. When a transitional animation is played, user control is returned at a different perspective than which it originated. If information is to be presented at 726, then information may be displayed at 746 and the user may remain in control during the presentation of the information. If a full animation is required at 728, then a full length animation sequence may be played at 748, but user control returned if an interrupt for the animation is provided under the user control. As indicated at 730, any effect or event may be implanted as a pin and the effect displayed at 750 before returning control to the user at 714.

FIG. 8 illustrates on example of a navigational sequence when a user approaches a “get in” pin. At 714, the user will perform navigational movements which will bring user toward the vehicle at 812. As the user moves toward the vehicle, pins will be displayed, as discussed below. Where pins are defined, they have a region of visibility and transition into view, as discussed below. A basic representation of pins is illustrated at 910a-910c

If a “get in” pin is selected at 816—indicating that a user wishes to enter the vehicle and view the interior of a vehicle—then at 820 an open user interaction may be needed. An open user interaction may be a navigational movement where a user makes a gesture such as opening a vehicle door. If the user performs the gesture, then an open animation following the user's action may be played at 822, and the user view will be changed via the animation from the perspective of the exterior of the vehicle to a display of the interior at 814. An interior view is illustrated at 890 with a plurality of pins 910d-910g.

Optionally at 826, a close door interaction may be chosen. As in reality, once inside a vehicle, a user may wish to close the door though which they just entered. If the user selects a close door user pin at 826, then at 828 a close door animation may be played. When the user interior is shown at 824, a plurality of interior pins may be displayed at 830. If an interior pin is selected at 832, then the effect of the pin is displayed at 838. The user may then select to get out of the vehicle at 834, and a get out sequence performed at 836.

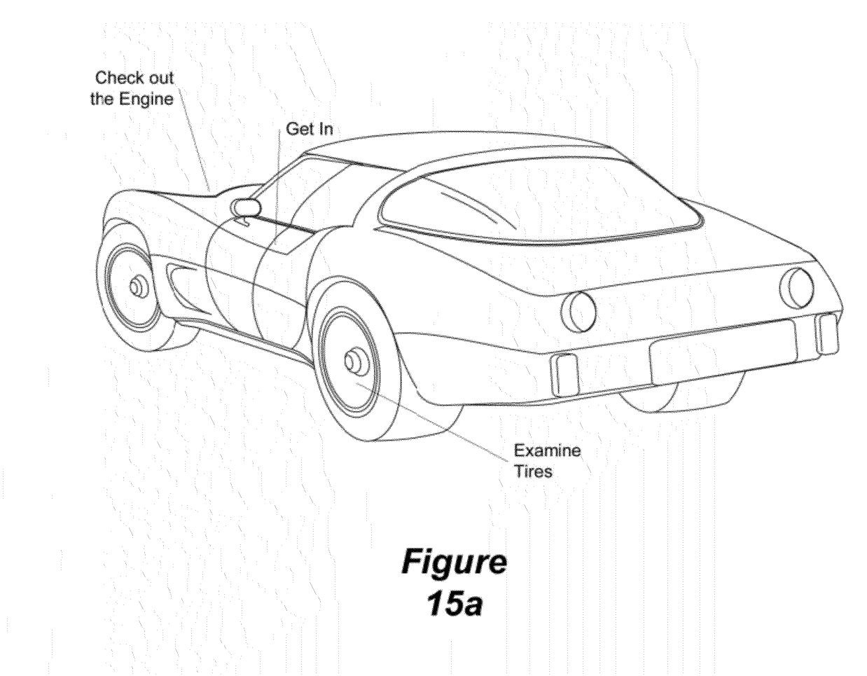

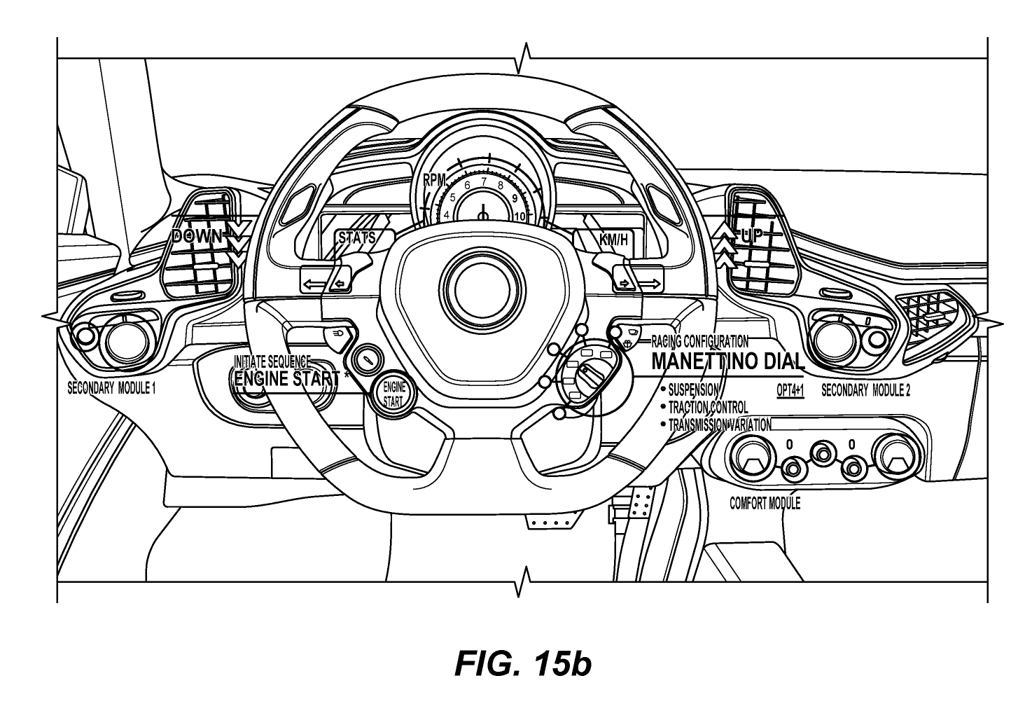

FIG. 15A illustrates an example of exterior pins which prompt a user to select certain functions displayed for the vehicle. The basic POIs illustrated in FIG. 15a include “check out the engine”, “get in” and “examine tires.” FIG. 15B illustrates a portion of a non-interactive, animated sequence showing detailed features which may be displayed for the interior of a Ferrari 458 Italia. For a specific car, interesting features—such as the up and down shifters—as well as working controls—such as engine start—bring a realistic feel to the navigation.

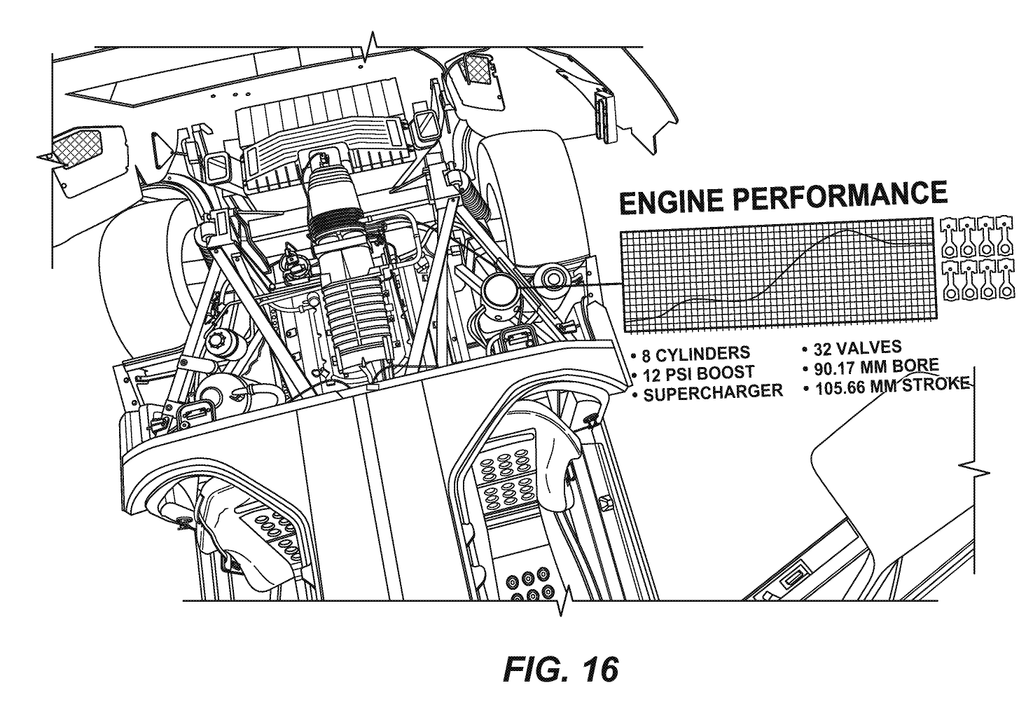

In addition to realistic perspectives, virtual perspectives can provide views which might not otherwise be available in the real world. FIG. 16 illustrates an overhead perspective in a portion of a non-interactive, animated sequence which may result from a user selecting an “explore engine” pin. FIG. 16 illustrates a Ford GT350 engine compartment with accompanying engine performance information in an overhead, perspective view virtual perspective. In one embodiment, POIs may be created to resemble the illustrated features of FIGS. 15B and 16.

When the technology is utilized for a human control interface for a vehicle navigation experience, a set of intuitive controls are provided which are tied to the player's body, represented inside of a 3D environment. This translates the user's motion within the confined area 1000 into an ability to walk, lean, bend, and crouch fluently and naturally. Capture device control parameters may be set and adjusted in order to provide a better experience. These parameters allow translation of the limited physical area 1000 into a relatively unlimited virtual area around the vehicle or other object. As discussed below, parameters may be set for actions inside and outside of a vehicle.

In one embodiment, a virtual player's height is normalized using a normalized height parameter. New information regarding changes in the user's height or weight can be blended in relative to a time frame. This time frame may be set to indicate how rapidly the average height takes in new data. A NormalizedHeight_m parameter is the height of the virtual player. A BlendNewHeightWeight parameter indicates how rapidly the height average takes in new data. A BlendAboveHeightFraction parameter indicate that only when the player's actual height is taller than this fraction of their average height so far do we average it in.

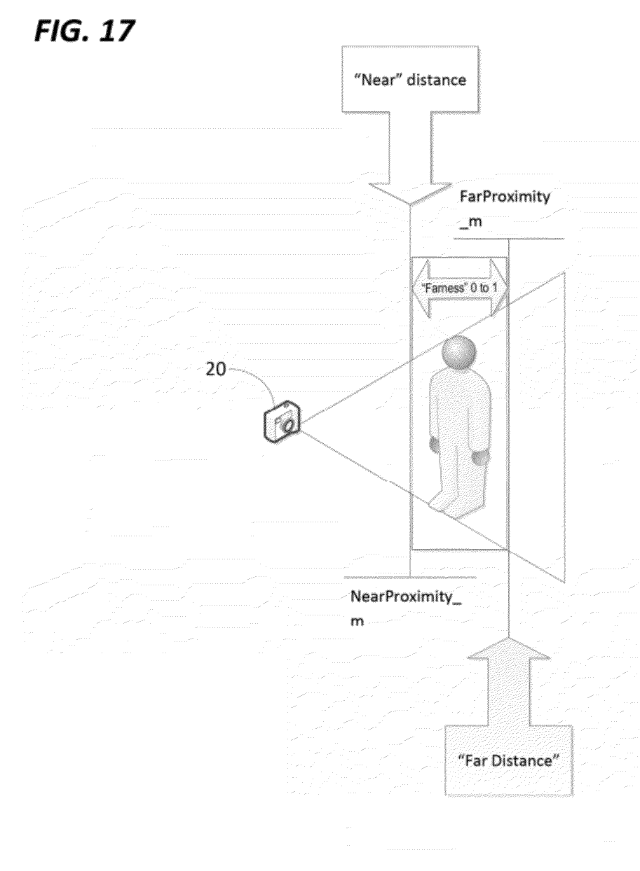

FIG. 17 illustrates a first set of real world physical settings to determine whether a user is considered near or far from the capture device 20. The near and far parameters can be utilized to determine a view in relation to the vehicle. Relative to the capture device 20, the NearProximity_m parameter is a distance at which the user is considered near to the capture device 20. The FarProximity_m distance is the distance from the capture device or further makes the player far from the capture device 20.

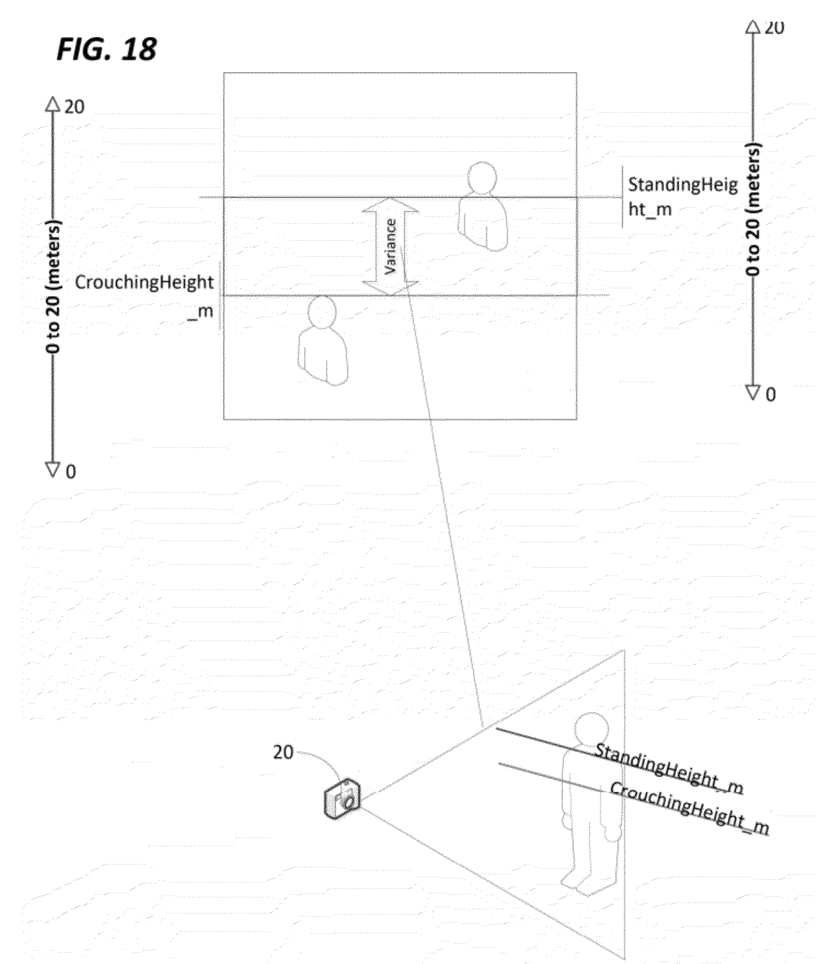

Illustrated in FIG. 18 illustrates the system parameters utilized to determine whether the user is crouching or standing. The couching height and standing height parameters, used to determine if a player is crouching or standing, are also selected to allow a user to participate in the navigational system if the user is sitting on a couch, as opposed to standing in front of a capture device. If the center of the head is above the StandingHeight_m height in meters, the player is considered to be standing. If the player center head is below the CrouchingHeight_m the player is considered to be crouching.

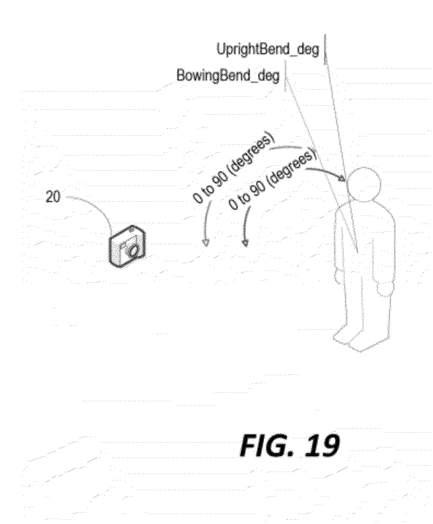

FIG. 19 illustrates parameters which may be adjusted to enable bowing. The UprightBend_deg is the angle to which a user may bend before the user is considered to be not standing upright. The BowingBend_deg is the angle below which a player is considered to be bowing.

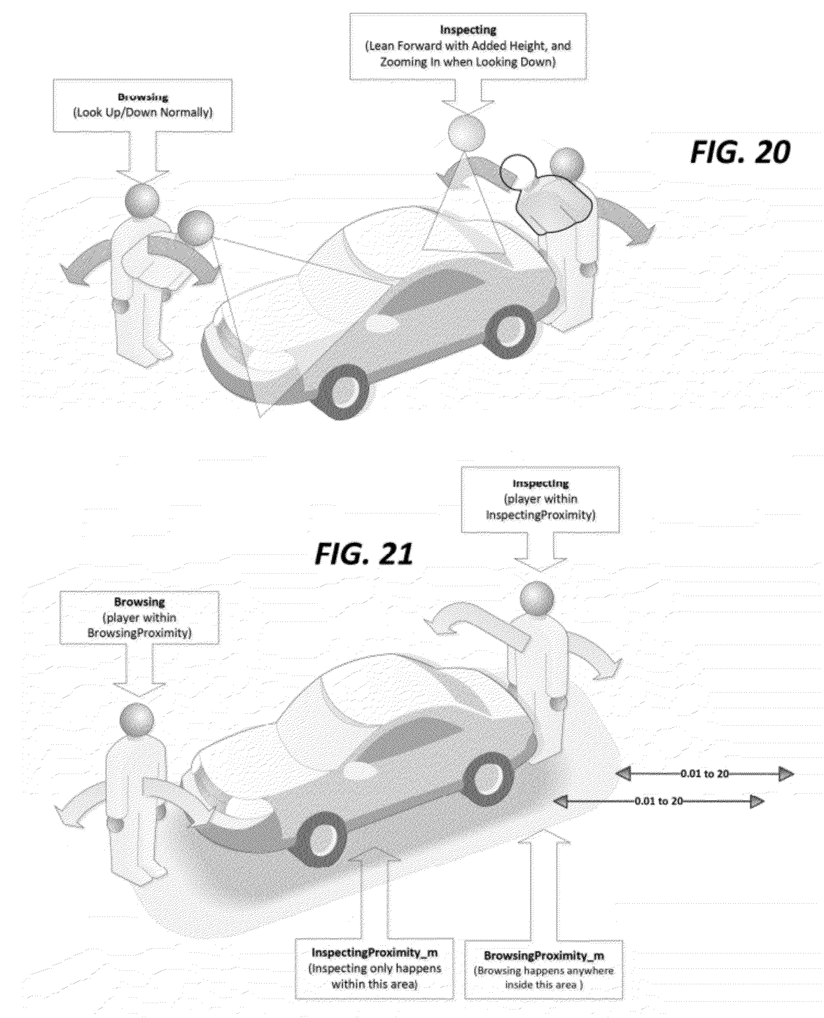

FIGS. 20 and 21 illustrate browsing and inspecting proximity. The distance a user is relative to the virtual vehicle and the capture device used by the system to determine whether a user is browsing the exterior of the vehicle or may desire to inspect an aspect of the vehicle more closely. Inspecting can be used to allow the system to zoom in on a portion of the vehicle. The browsing proximity distance (BrowsingProximity_m) is the distance from the capture device at which a user is considered to be browsing a vehicle. The inspecting proximity distance (InspectingProximity_m) is the distance from the capture device where the user is considered to be inspecting a vehicle. Inspecting may be considered to be a user leaning forward with added height and zooming in when looking down, whereas browsing is considered to be looking up and down normally. For inspection, players are within the inspecting proximity and bending over, whereas browsing happens within a browsing proximity and generally in an upright position.

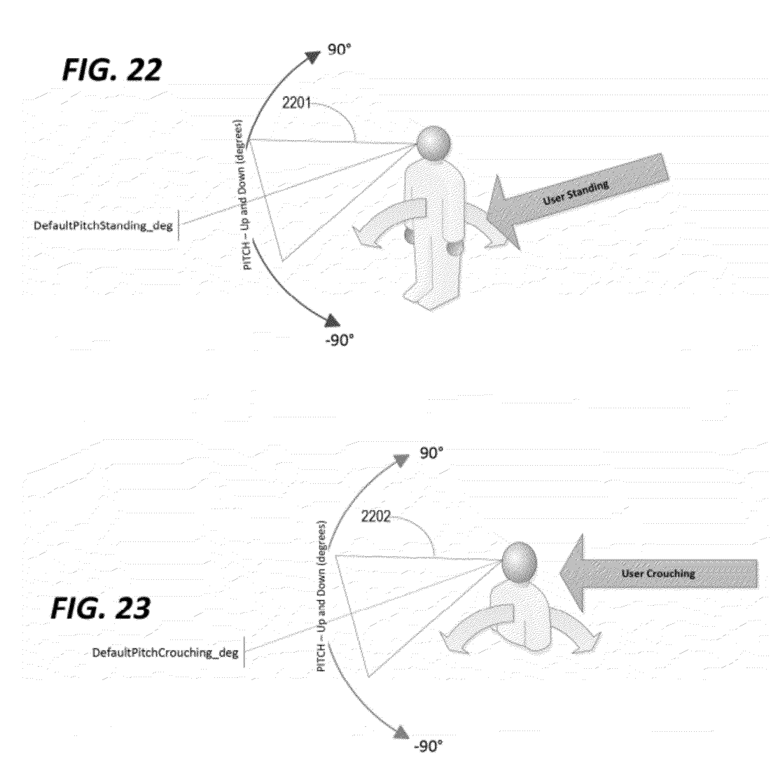

FIGS. 22 and 23 illustrate exterior capture device 20 facing parameters. In FIG. 22, the ExteriorDefaultPitchStanding_deg is the starting angle at which the user virtual perspective appears in the virtual world when the user is standing and looking straight ahead. The pitch relative to this angle is measured in degrees. The ExteriorDefaultPitchCrouching_deg parameter is the up down tilt of the user's view when the user is crouching and illustrated in FIG. 23. Angle 2201 is the starting angle at which the user's view is looking when the user is standing, looking straight. Angle 2202 is the default angle at which the user's virtual view is looking when Crouched, looking straight.

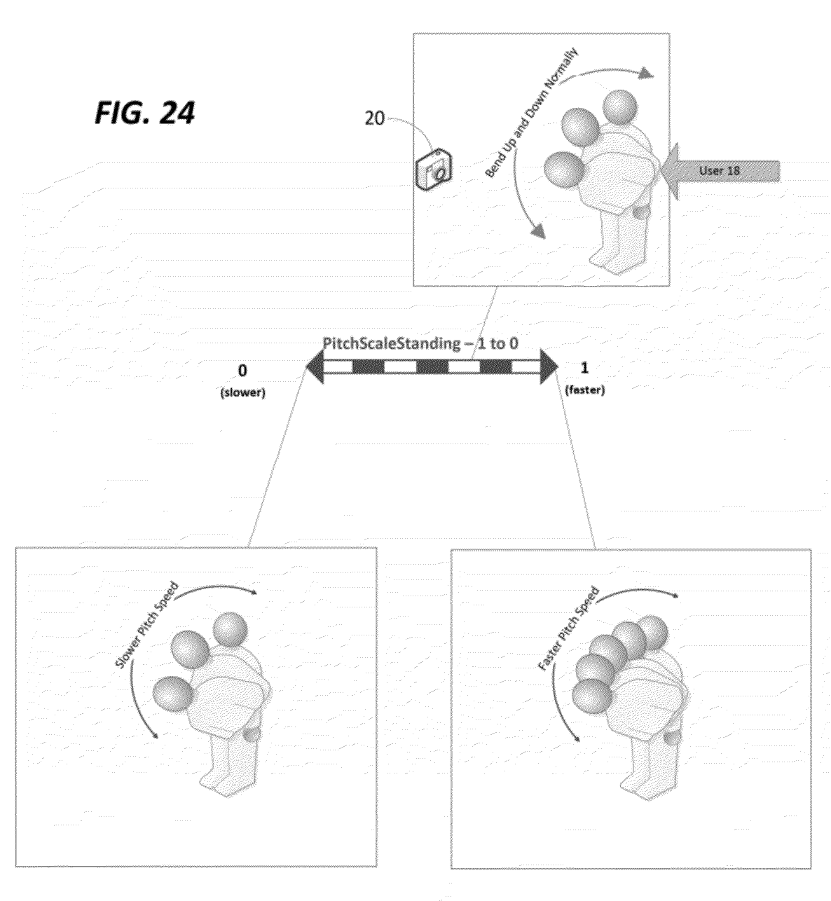

The ExteriorPitchScaleStanding defines how much the user's virtual view tilts up and down versus how much the user leans forward and backward while standing. This is illustrated in FIG. 24. The pitch scale standing is a factor between 0 and 1 which causes the virtual game perspective in the game to pitch up and down faster or slower. The pitch scale standing is equivalent to the ExteriorPitchScaleCrouching parameter. This measures how much the user's virtual view tilts up and down versus how much the user leans forwards and backwards while standing.

In these parameters, it is not primarily speed that is controlled. Speed controls the secondary effect of the overall angle of the user's movement being scaled to the angle of the virtual view's movement. This means that if a scale is 0.5, the default pitch is 0° and the capture device could detect one's skeleton when one is touching one's toes, the in game user's virtual view would at most look 45° down when one is touching one's toes because of the scale limitation.

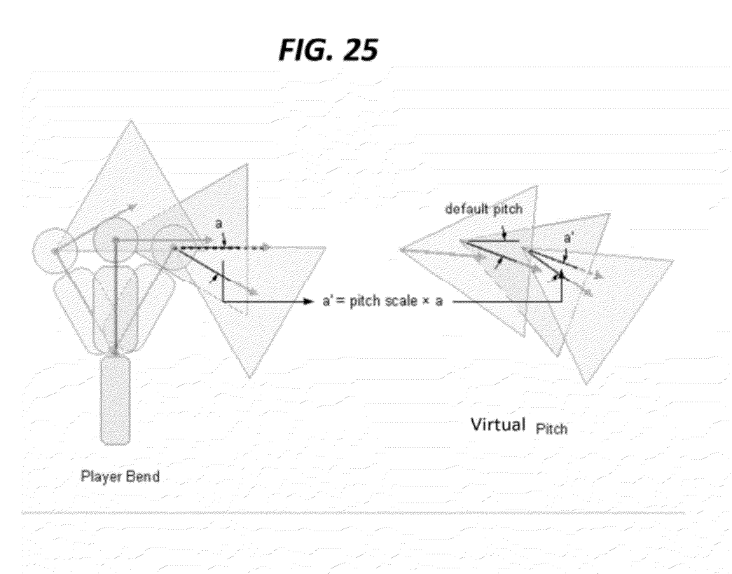

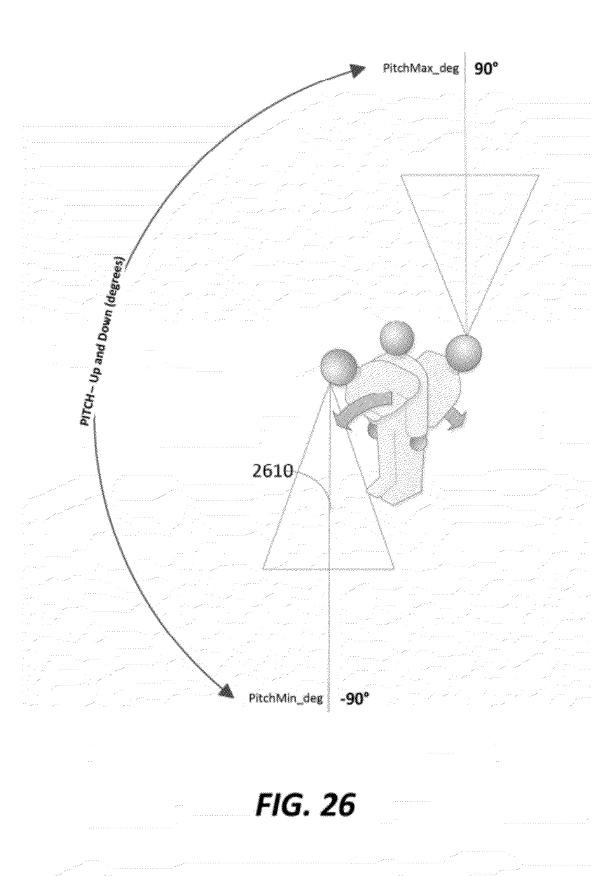

FIGS. 25 and 26 illustrate the ExteriorPitchMin_deg and ExteriorPitchMax_deg which defines how the perspective view of the user will tilt up and down relative to a user's real world movements. The real world scale must be translated to the virtual environment. As illustrated in FIG. 25 a player has a particular pitch scale which is translated to the virtual view's pitch scale. The player's pitch scale A′ is translated from the player's pitch angle A and a scale factor. If a user looking directly ahead is at 0° then a maximum pitch is 90° where the user is looking straight up and a minimum pitch is −90° where a user is looking straight down. This is translated from the user's actual movements to the rendering of the user's virtual view within the 3D display. FIG. 26 illustrates ExteriorPitch Min and Max as defining the furthest a user can look up and down for both Standing and Crouching.

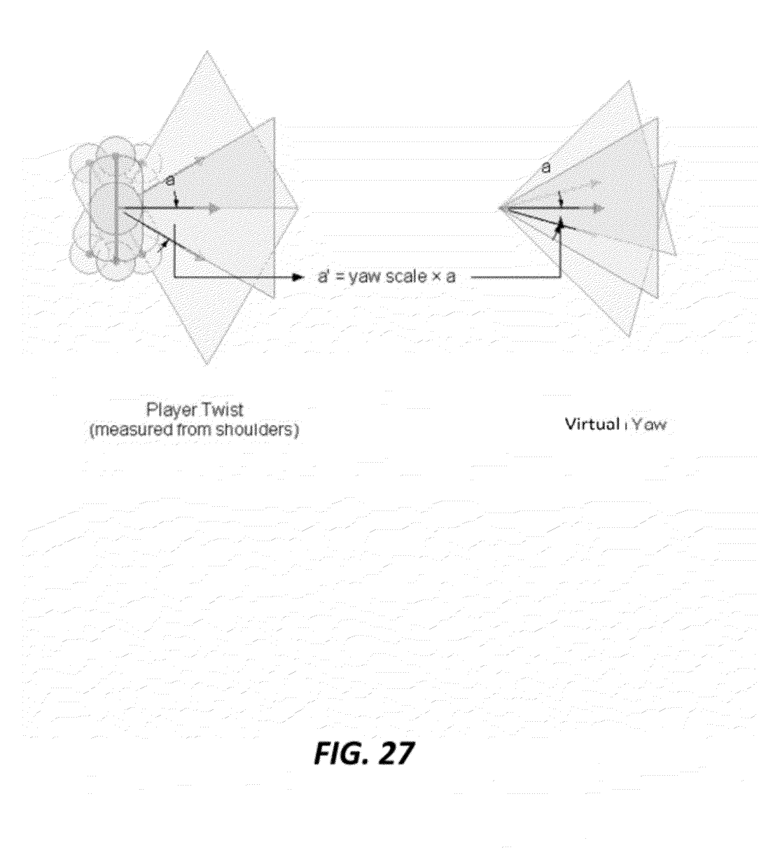

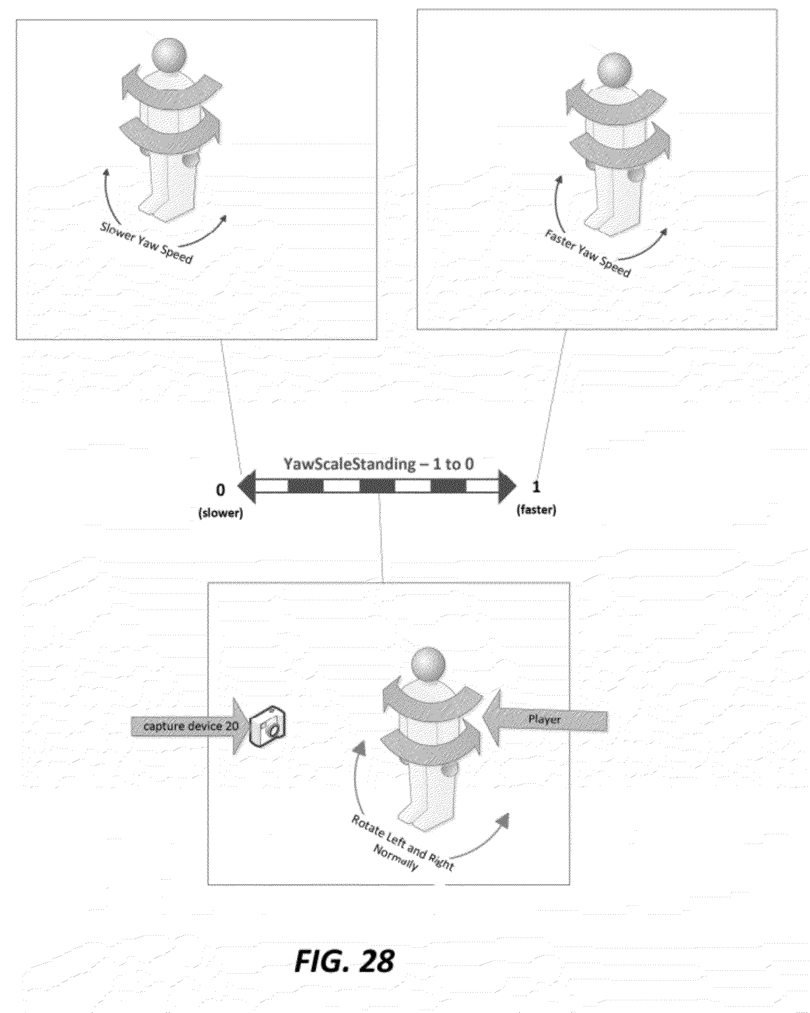

FIGS. 27 and 28 illustrate the ExteriorYawScaleStanding and ExteriorYawScaleCrouching parameters. The Yaw is the rotational movement of the user about the axis passing from the user's head through the user's feet. Like the Pitch parameters discussed above, the Yaw parameters define the amount of user twist and translation of the user twist into the virtual view. The ExteriorYawScaleStanding and ExteriorYawScaleCrouching are the speed factor at which the user's virtual view rotates left and right versus how much the player rotates their shoulders left and right while crouching. A YawScaleStanding causes the virtual view in game to yaw left and right faster or slower. FIG. 27 illustrates a translation of the user's twist measured from the shoulders at an angle A to a capture device 20 view Yaw A′. A′ is a function of the angle A and a scaling factor.

Interior view parameters are similar to those discussed above and include an InteriorDefaultPitchStanding_deg and InteriorDefaultPitchCrouching_deg equivalent to the exterior facing parameters DefaultPitchStanding in DefaultPitchCrouching discussed above, but for the interior of a vehicle. Likewise, the InteriorPitchScaleStanding and InteriorPitchScaleCrouching are equivalent to the ExteriorPitchScaleStanding and InteriorPitchScaleStandings illustrated above. Similarly, an InteriorPitchMin and InteriorPitchMax are equivalent to the ExteriorPitchMinimum and ExteriorPitchMaximum degree discussed above. An InteriorYawScaleStanding and InteriorYawScaleCrouching parameters which are similar to ExteriorYawScaleStanding and ExteriorYawScaleCrouching parameters discussed above.

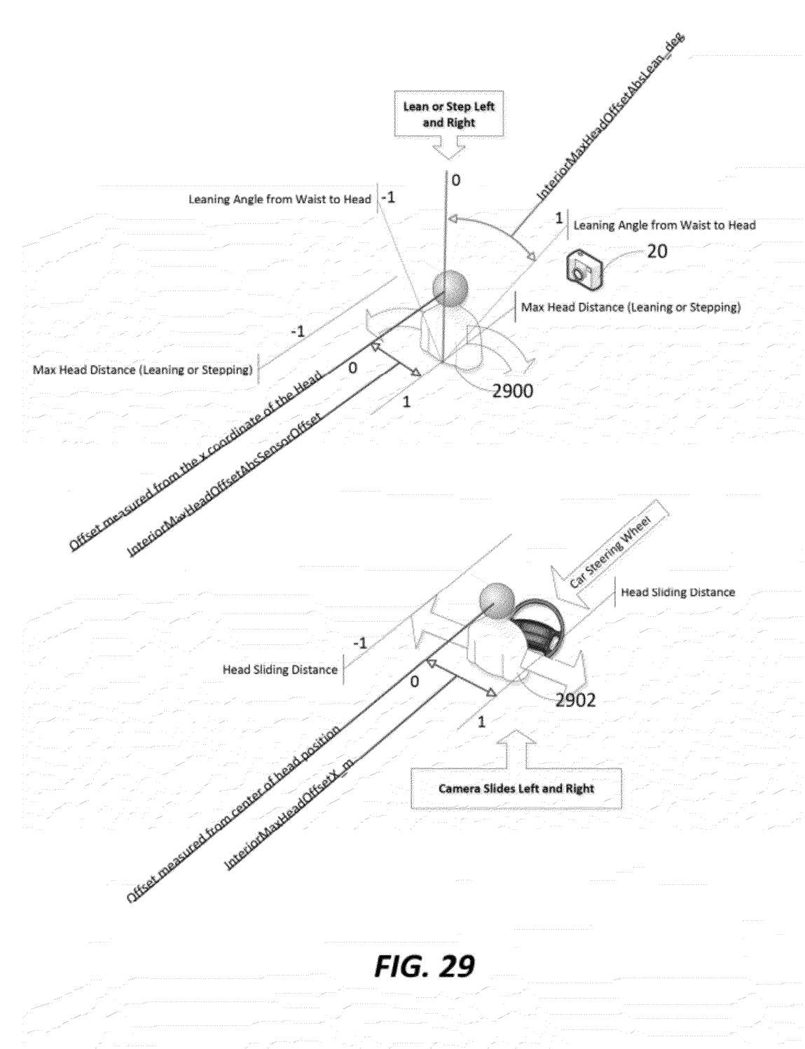

FIG. 29 illustrates interior position coordinate system and parameters used when a user is inside a vehicle within the motion based vehicle navigation experience. In FIG. 29, the top FIG. 2900 is the actual user relative to a capture device 20 while the bottom user 2902 is a virtual perspective within the game. As the user 2900 leans or steps left and right, the perspective of 2902 will move correspondingly left or right relative to the motion of the user 2900. An InteriorMaxHeadOffsetX_m is a factor limiting the amount of movement left or right from center when a user is in the vehicle. This offset is measured between 0 and 1 relative to the X coordinate of the head as illustrated in FIG. 29. The InteriorMaxHeadOffsetABSLean_deg is the amount of lean in degrees that corresponds to the maximum left/right head movement of a user when inside of the vehicle. The InteriorMaxHeadOffsetABSSensorOffset is the movement left and right that corresponds to the maximum left/right head movement of a user within a vehicle. The horizontal distance is not measured from stepping but rather from the X coordinate of the head as illustrated in FIG. 29 with respect to user 2900 and 2902. The lean and head X offset are then added and clamped between −1 and 1. The lean is the leaning angle from the waist to the head.

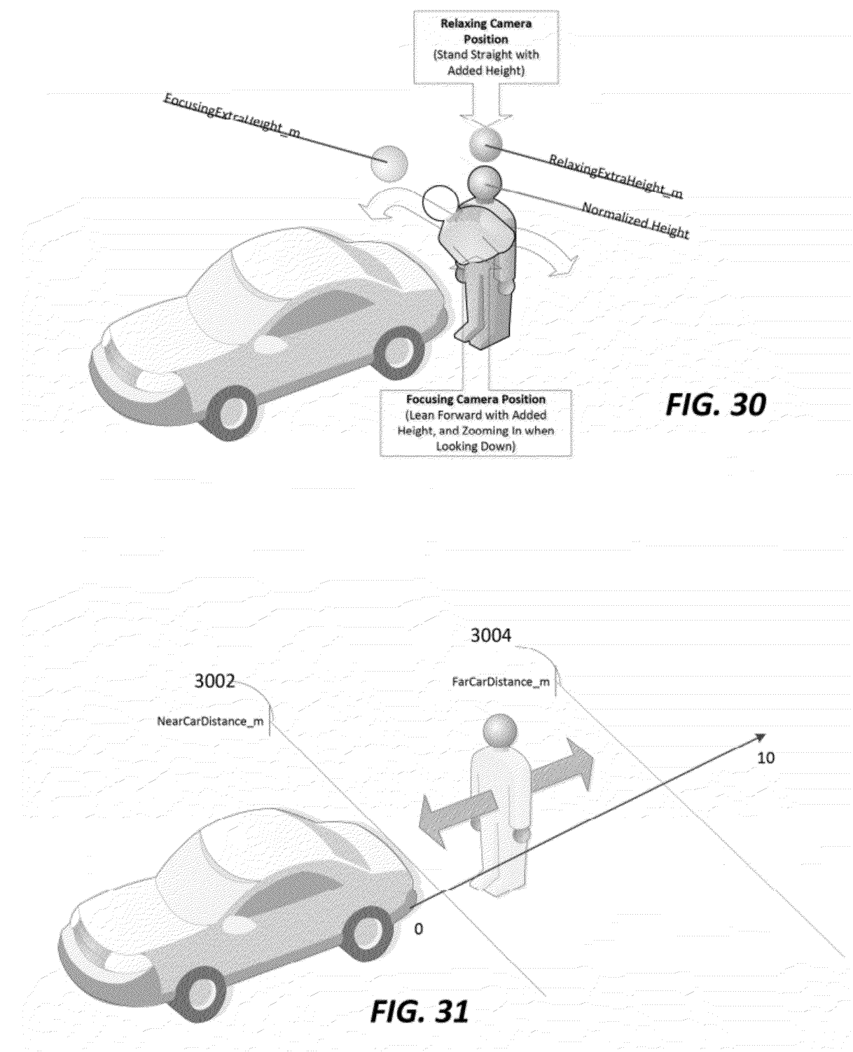

FIG. 30 illustrates exterior focusing parameters. The exterior focusing parameters are illustrated relative to the normalized height, discussed above. The system compensates for a user's height—whether too tall or too short—to provide a normalized view of a vehicle. In exterior focus, a user is contributed a RelaxingExtraHeight_m which is how much extra height to add when the user is in a relaxing virtual view position standing straight with added height. The FocusingExtraHeight_m is a parameter indicating how much extra height to add when a user is focusing on a particular item. The RelaxingFov_deg is the capture device 20 field of view when relaxing and the FocusingFov_deg is the virtual field of view when focusing. A focusing virtual view position is generally determined when the user is leaning forward with added height and zooming when looking down. This is how the system determines via gesture that the user wishes to focus on a particular element of the vehicle.

FIG. 31 illustrates the exterior distance parameters utilized in determining how far and near a person is to a vehicle. The NearCarDistance_m 3002 is the closest one can get to a vehicle and occurs when a person is near. The FarCarDistance_m 3004 likewise is the farthest distance allowed from the vehicle in meters.

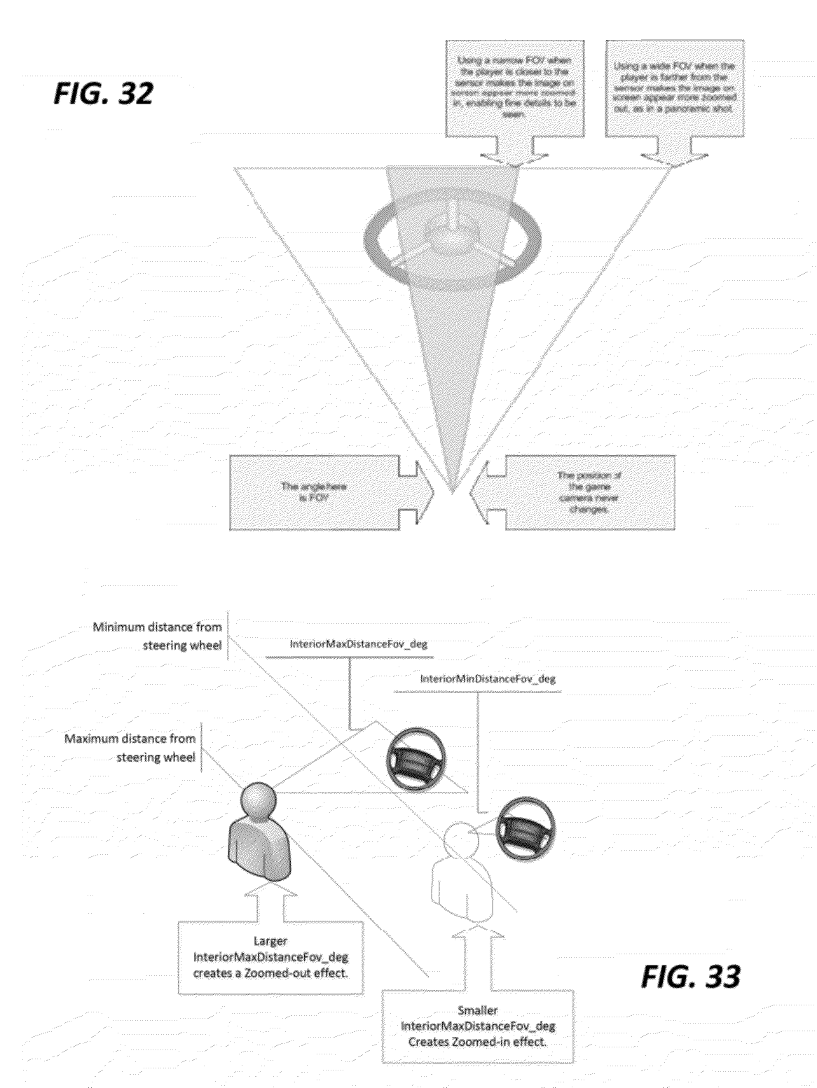

Virtual field of view parameters are illustrated in FIGS. 32 and 33. FIG. 32 illustrates the practical effect of moving a user relative to a capture device. The field of view is the angle of the eye. The field of view is narrower when zoomed in and although the capture device 20 never moves forward and backwards with respect to a steering wheel, rather, a player moves forward and backward with respect to a capture device which translates into the capture device 20 field of view changing. As illustrated in FIG. 33, the position of the game capture device 20 does not change, rather, when using a narrow field of view is required when the player is closer to the sensor. This makes the image on screen appear more zoomed in enabling fine details to be seen. A wide field view is utilized when a player is farther from the capture device, making the image on the screen appear more zoomed out in a panoramic shot. The InteriorMinDistanceFov_deg is a field of view when the user is closest to the steering wheel and InteriorMaxDistanceFov_deg is a field of view when furthest away from the steering wheel. These parameters are illustrated in FIG. 45.

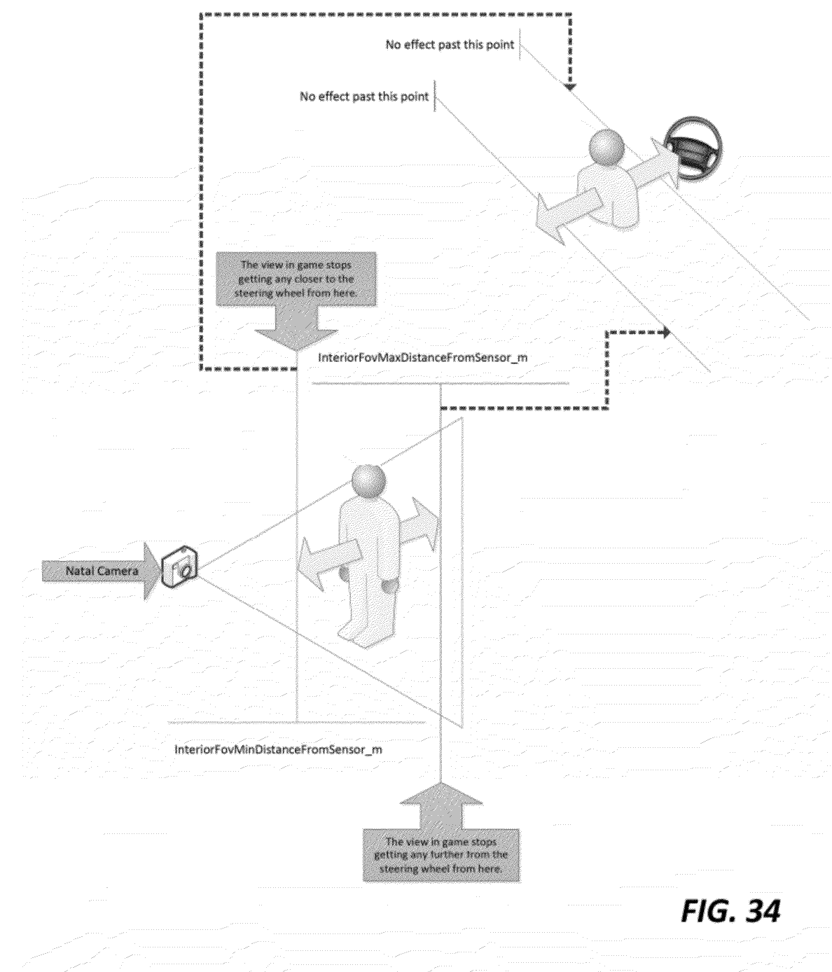

FIG. 34 illustrates the minimum and maximum distance from the capture device after which no effect on the virtual perspective movement within the navigation system occurs. The InteriorFovMinDistanceFromSensor_m parameter provides how close the user can approach a capture device before it ceases to have any additional effect on the interior field of view. Likewise the InteriorFovMaxDistanceFromSensor_m limits how far a user can get away from the capture device before it ceases to have any additional effect on the interior field of view. This is illustrated in FIG. 34. As illustrated therein, the view in the game stops getting any further away once the user reaches the maximum distance from the sensor.

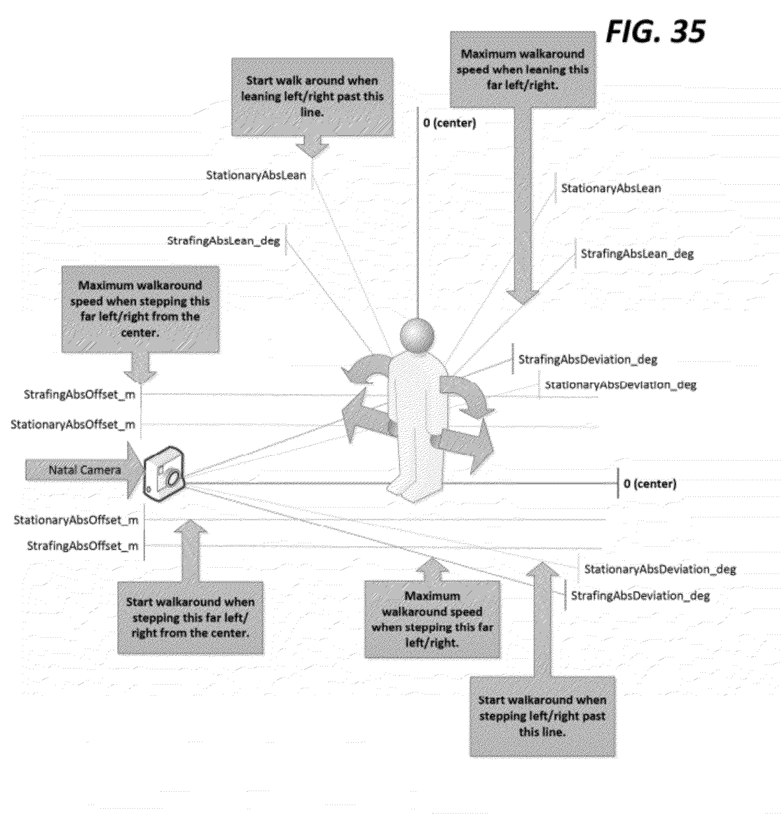

FIG. 35 illustrates parameters utilized to illustrate a user walking around the vehicle. The walk around parameters indicate to the system that a user intends to walk around a vehicle as evidenced by the user's movements left/right leaning. The user starts to walk around when leaning left or right past a StationaryAbsLean angle. The StrafingAbsLean_deg parameter indicates that a user is walking at top speed when the user has leaned this far. The StationaryAbsOffset_m will create the user movement when the user has moved this distance off center while the StrafingAbsOffsetm movement distance indicates that one is walking at top speed. The StationaryAbsDeviation_deg also indicates that a user has started walking when this far off angle from the capture device and the StrafingAbsDeviation_deg indicates a top walking speed. All these relative gestures will begin the user movement around the vehicle if the user is in the proper location relative to the vehicle. The SlowStrafingSpeed_m_per_frame is a slower speed used when crouching and leaning and stepping from left to right while the FastStrafingSpeed_m_per_frame is top speed when used when standing and leaning and stepping from left to right.

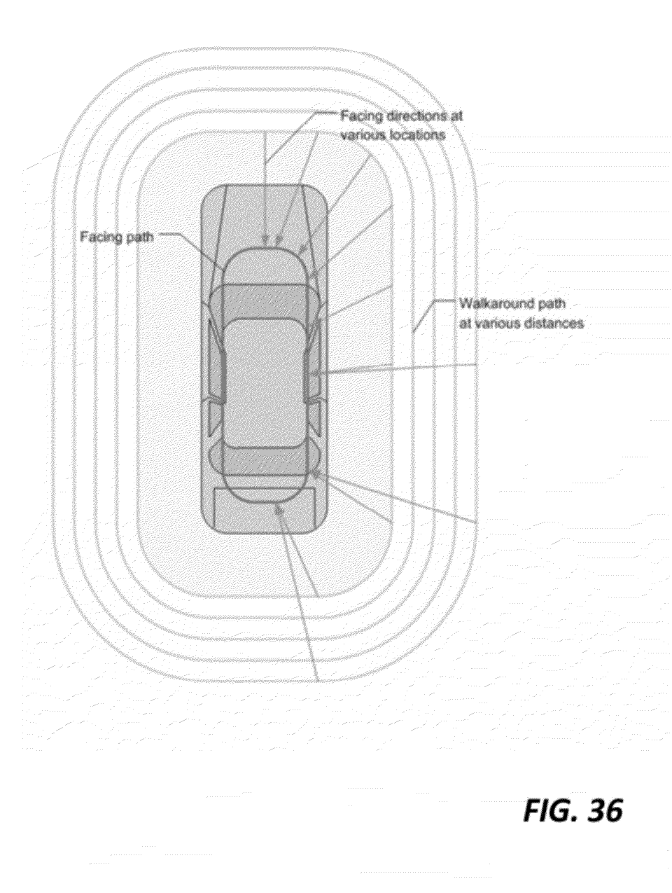

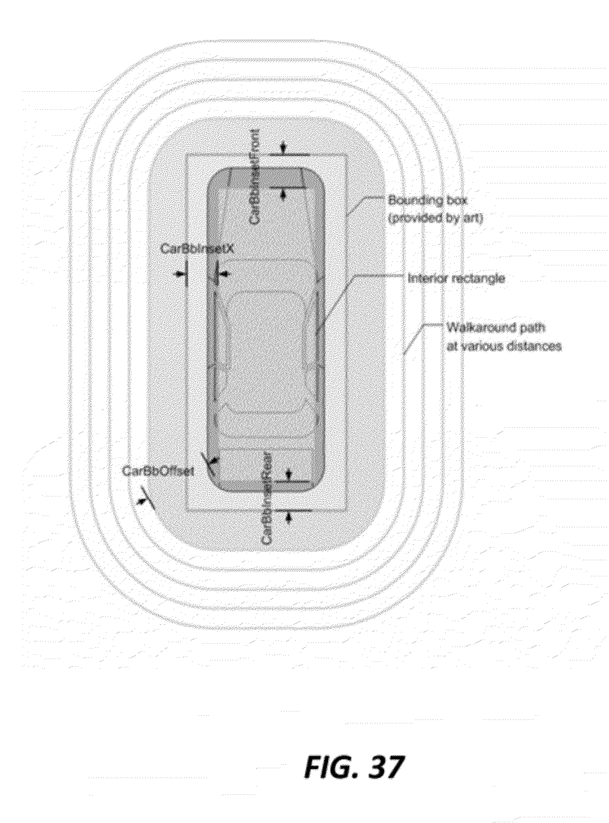

FIGS. 36 and 37 illustrate the vehicle walk around path and various facing directions at various distances. The CarBbInsetX_m is how far in from the left or right sides of the vehicle's bounding box that the center of the rounded corners are placed. The vehicleBbInsetFront_m is how from in from the front of the vehicle's bounding box to place the centers of the rounded corners of the walking round path. The vehicleBbInsetRear_m is how far in from the back of the vehicle's bounding box to place the centers of the rounded corners and the vehicleBbOffset_m is the radius of the rounded corners.

When facing the vehicle, additional parameters are used. The FacingCarBbInsetX_m parameter is how far in from the left/right sides of the vehicle's bounding box to place the centers of the rounded corners. The FacingCarBbInsetFront_m parameter is how far in from the front of the vehicle's bounding box to place the centers of the rounded corners. The FacingCarBbInsetRear_m is how far in from the back of the vehicle's bounding box to place the centers of the rounded corners. The FacingCarBbOffset_m is the radius of the rounded corners. A CollisionSphereRadius is the minimum distance from the bounding boxes or other bounding surfaces of the vehicle that the user's virtual view will be kept at, such collision detection provided to prevent the user's virtual view from clipping through rendered geometry not contained in the vehicle's bounding box, such as doors or other compartment covers that may protrude from the vehicle's bounding box when opened.

As noted above, pins may have proximity and zones. The activation of a POI may be determined by the user's proximity to the POI, parameters being specified similar to those for the visibility cone, and possibly coinciding with them. Other than using proximity as the activation cue, these proximity pins or zones would function in a similar way to the hand cursor activated POIs already discussed, triggering animated sequences and the like. Activation of such proximity pins may be predicated on the user assuming a certain pose or range of poses during the activation time period, such as leaning in a general direction, or the activation time period may instead be an activation progress that is controlled by engaging in a range of poses or gesture. In addition POIs may control the visibility of other POIs.

Each POI pin has a list of settings that can be tuned individually and can be accessed individually. Each of these parameters may be used by the gesture detection system to determine the position of the user and define gestures controlling input to the gaming system.

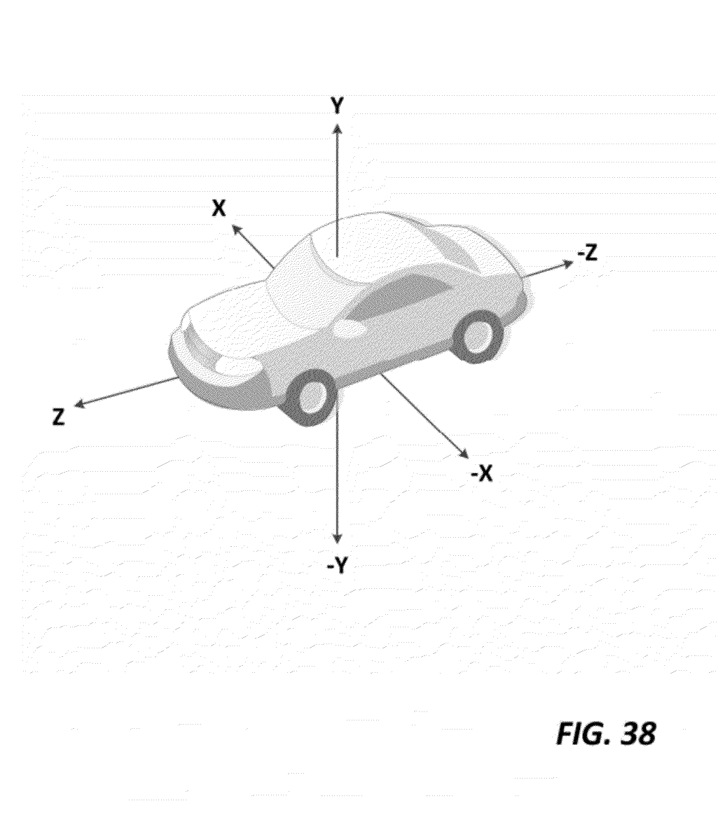

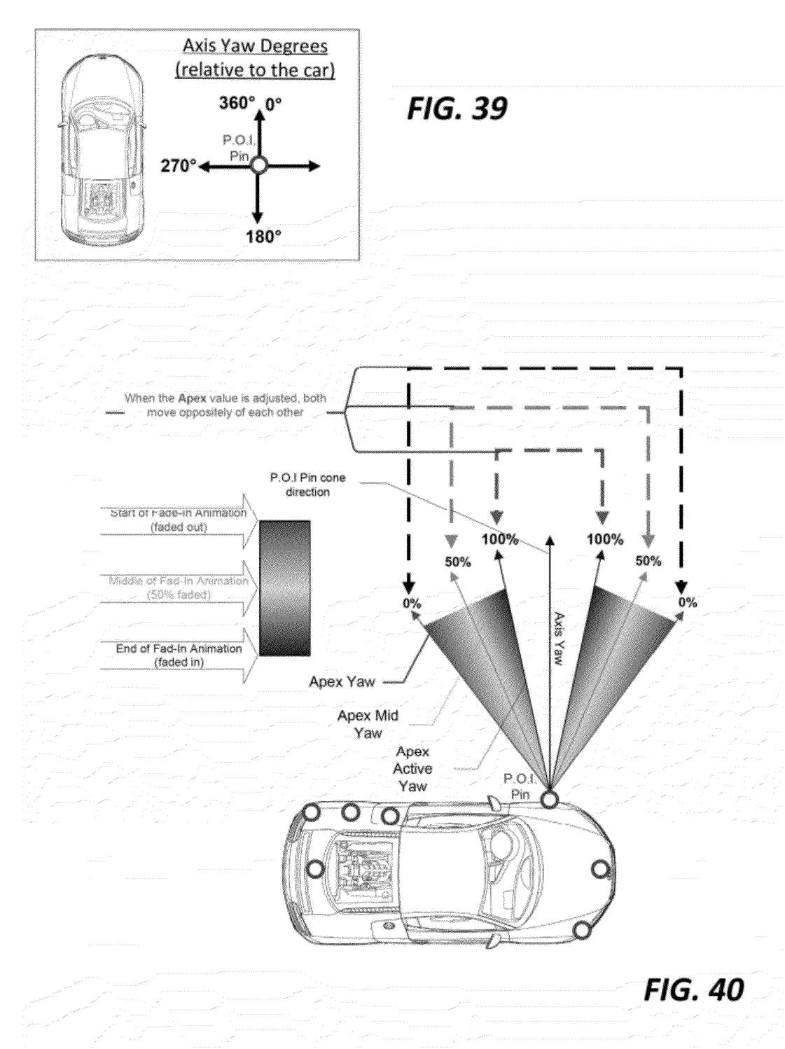

FIG. 38 illustrates a vehicle coordinate system. FIG. 39 illustrates the axis yaw degrees relative to the vehicle, and FIG. 40 illustrates the apex value of how the fade in and fade out of each pin may be controlled.

With reference to FIGS. 38-40, a PosX setting is the position of the pin on the X axis in vehicle space coordinates. Starting in the center of the vehicle, the X axis runs left and right (passenger side is +x and driver side is −x). A PosY setting is the position on the Y axis in vehicle space coordinates. Starting at the bottom center of the vehicle, the Y axis runs up and down (above the floor of the vehicle and up is +y and below the floor of the vehicle and down is −y). A PosZ setting is the position on the Z axis in vehicle space coordinates. Starting at front seat position, the Z axis runs front-to-back on the vehicle (The front of the vehicle is +z and back is −z). An AxisYaw parameter is used to determine the orientation of the visibility cone in terms of spherical coordinates. This is equivalent to the spherical coordinate angle known as azimuth. An ActiveYaw parameter is used to determine where the object is fully in view and available to be activated. A MidYaw parameter is the total quantity of degrees relative to the AxisYaw used to control when the control will be faded in to 50% of visibility. This number does not indicate a latitude but rather a total number of degrees relative to the AxisYaw. For Example, a MidYaw of 50 degrees sweeps out an area centered at the AxisYaw degrees +/−25 degrees to each side. An ApexYaw parameter is a total quantity of degrees relative to the AxisYaw used to control when an image of the pin will start to fade in from 0%. This is used to test if the user view virtual perspective is at a degree relative to the POI based on +/−½ of the ApexYaw relative to the AxisYaw. This follows the same rules involving the speed of how the control fades in as the Near, Mid, Far distance curve above.

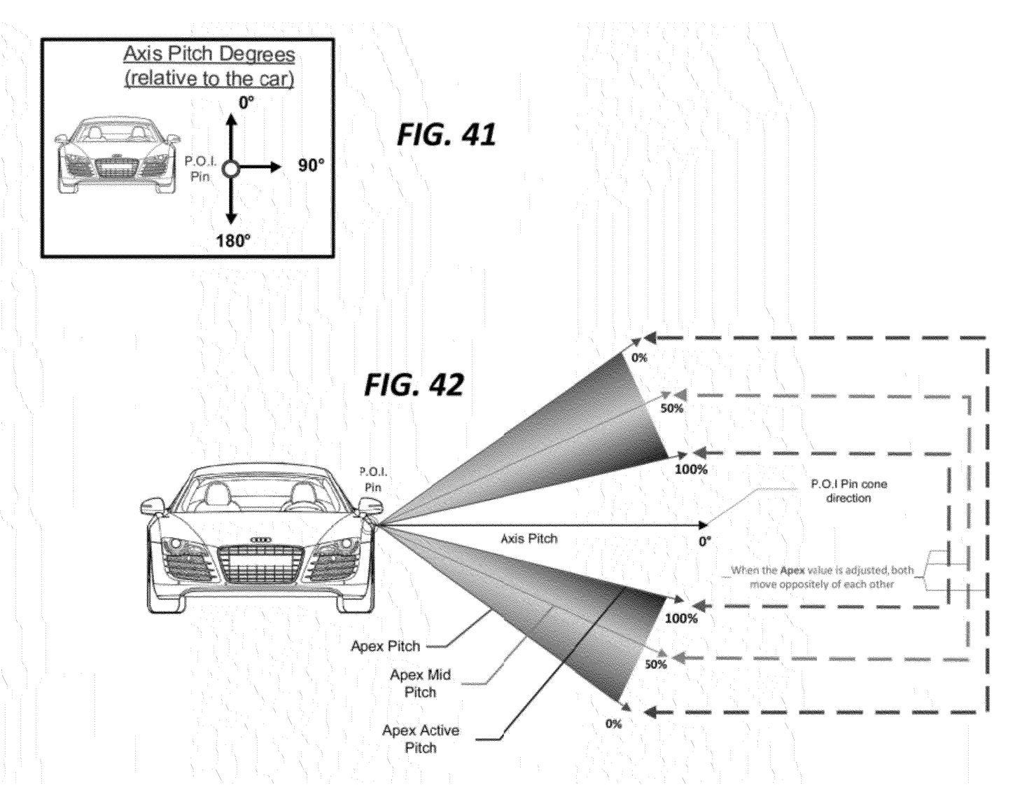

FIG. 41 illustrates the Axis pitch relative to the vehicle, and FIG. 42 illustrates the apex pitch relative to the vehicle. With reference to FIGS. 41 and 42, an AxisPitch parameter is used to determine the orientation of the visibility cone in terms of spherical coordinates. One can think of this as the spherical coordinate angle known as inclination. An ActivePitch parameter is used to determine where the object is fully in view and available to be activated. A MidPitch parameter is a total quantity of degrees relative to the AxisPitch used to control when the control will be faded in to 50% of visibility. Again, this number does not indicate a latitude, it indicates a total number of degrees relative to the AxisPitch. For example, a MidPitch of 50 degrees sweeps out an area centered at the AxisPitch degrees +/−25 degrees to each side. An ApexPitch parameter is a total quantity of degrees relative to the AxisPitch used to control when the control will start to fade in from 0%; again this is used to test if the virtual perspective is at a degree relative to the POI based on +/−½ of the ApexPitch relative to the AxisPitch. This follows the same rules involving the speed of how the control fades in as the Near, Mid, Far distance curve above.

A Near parameter is assigned each POI and constitutes a distance away from the POI at which point a POI may become selectable. Being closer to a POI than Near indicates that the control is active in terms of its distance curve. A Mid parameter is a distance at which the POI is 50% faded into visibility. Moving the Mid value closer to “Near” will create a faster ramp up for the control to fade into visibility as the player gets closer. Putting Mid closer to “Far” means that the POI control will reach 50% faded in faster as the player walks between “Far” and “Mid” with a slower fade-in between “Mid” and “Near”. A Far parameter is a distance at which the POI is 0% faded into visibility. A YawVisibility parameter allows one to know when the field of view cone for the pin is visible on its X axis. When the number is 1, it's fully visible. Anything under 1 is the level of how visible the pin is. A PitchVisibility parameter allows one to know when the field of view cone for the pin is visible on its Y axis. When the number is 1, it's fully visible. Anything under 1 is the level of how visible the pin is.

A DistanceVisibility parameter lets one know when the field of view cone for the pin is visible on its Z axis. When the number is 1, it's fully visible. Anything under 1 is the level of how visible the pin is. A virtual perspective FOVScale parameter sets the scale of FOV for when within the activated proximity of the specified pin. A virtual perspective WalkSpeedScale parameter sets the speed at which the virtual perspective moves when within the activated proximity of the specified pin.

An IconScale parameter adjusts the visual size of the specified pin. An InstantActivate parameter allows for pins like the horn that one wants to activate instantly, i.e., no hover time. A MinActivateZ parameter defines how far out from one's body one's arm has to be to activate the pin. This could be used, for example, to require one to have to extend one's hand to activate (honk) the horn. A LookAtExtraHeight parameter is an amount of extra height to add when one is in the influence of the pin. It's useful when the intent of the pin is to have one look at something, and one needs to be taller for a good view. This is a gradual ramp-up. A LookAtBlend parameter smooths out the transition from normal aim of the virtual perspective view to when it snaps to aiming at the desired pin with the “Look At” feature turned on. The actual amount of blend is a ramp-up to this maximum blend amount. LookAtPosX, LookAtPosY and LookAtPosZ are three parameters defining a set of coordinates of a point the virtual perspective will look at when under the influence of the pin. The influence ramps-up gradually, so the view gradually adjusts (from looking at a point on the inner rounded rectangle of the vehicle to the target point).

Examples of locations at which POI pins may be placed include at the following locations within the interfaces: PaintCar; LeftFrontWheel; ExteriorTour; ExteriorOpenDoor; ExteriorCloseDoor; GetInCar; InteriorTour; ExitCar; InteriorOpenDoor; InteriorCloseDoor; StartCar; StopCar; TailLight; HeadLight; and Engine.

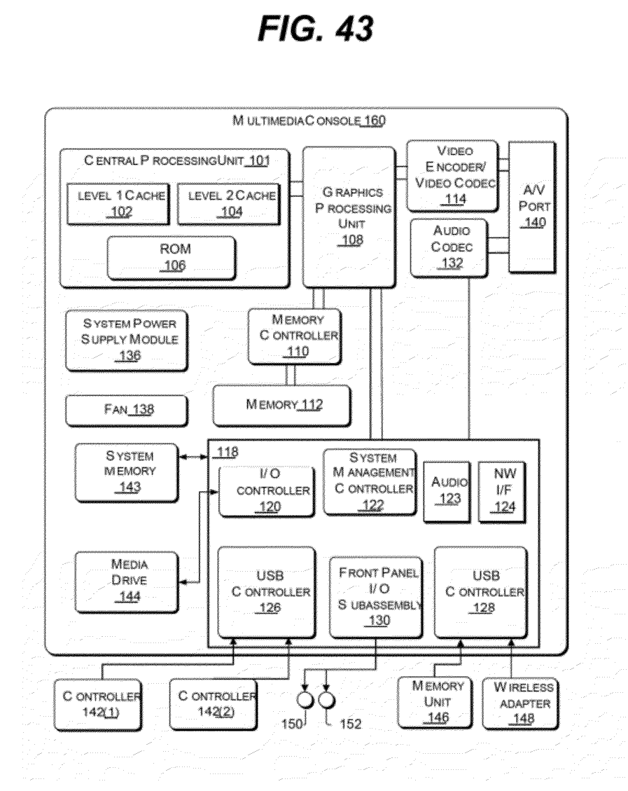

FIG. 43 illustrates an example of a computing environment that may be used to implement the computing environment 12 of FIGS. 1-2. The computing environment 100 of FIG. 43 may be a multimedia console 160, such as a gaming console. As shown in FIG. 43 the multimedia console 160 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 160 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 160 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 160. Application data may be accessed via the media drive 144 for execution, playback, etc. by the multimedia console 160. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 160. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 160.

The CPU 101, GPU 108, memory controller 110, and various other components within the multimedia console 160 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 160 is powered ON, application data may be loaded from the system memory 143 into memory 112 and/or caches 102, 104 and executed on the CPU 101. The application may present a graphical user interface that provides a consistent user experience when navigating to different media types available on the multimedia console 160. In operation, applications and/or other media contained within the media drive 144 may be launched or played from the media drive 144 to provide additional functionalities to the multimedia console 160.

The multimedia console 160 may be operated as a standalone system by simply connecting the system to a television or other display. In this standalone mode, the multimedia console 160 allows one or more users to interact with the system, watch movies, or listen to music. However, with the integration of broadband connectivity made available through the network interface 124 or the wireless adapter 148, the multimedia console 160 may further be operated as a participant in a larger network community.

When the multimedia console 160 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 160 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 74 and 76 and capture device 60 may define additional input devices for the console 160.

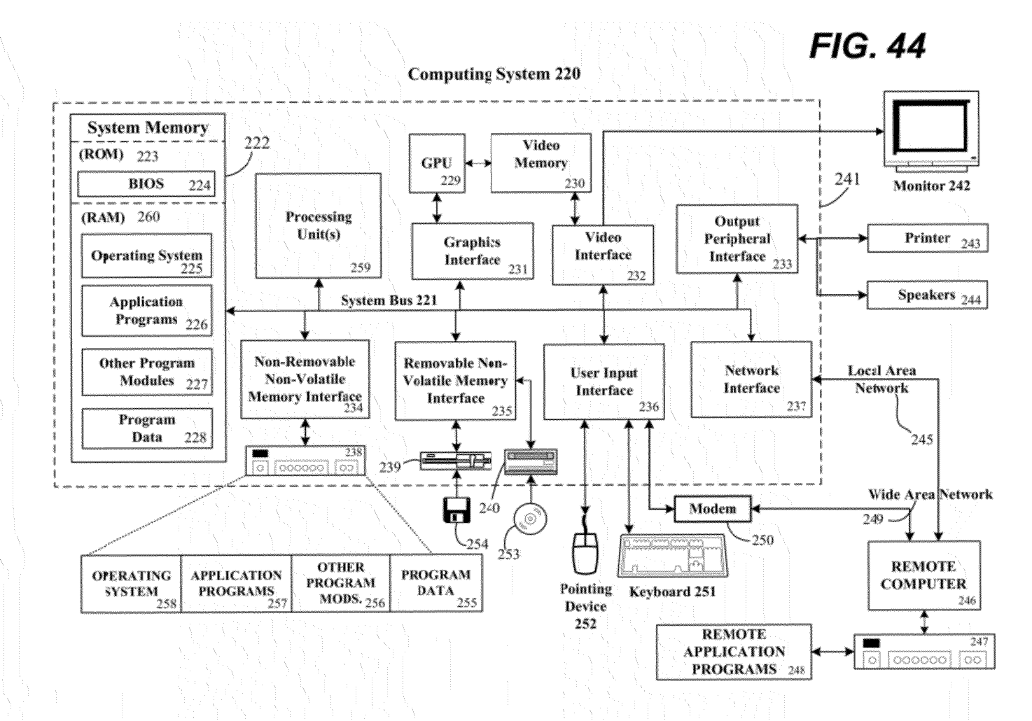

FIG. 44 illustrates another example of a computing environment 220 that may be used to implement the computing environment 12 shown in FIGS. 1A-2. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples, the term circuitry can include a general-purpose processing unit, memory, etc., configured by software instructions that embody logic operable to perform function(s). In embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 44, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 44 illustrates operating system 225, application programs 226, other program modules 227, and program data 228.

The computer 241 may also include other removable/non-removable, volatile/nonvolatile computer storage media. By way of example, FIG. 44 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 44, provide storage of computer readable instructions, data structures, program modules and other data for the computer 241. In FIG. 44, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 74, 76 and capture device 60 may define additional input devices for the computer 241. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 44. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 44 illustrates remote application programs 248 as residing on memory device 247. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of providing a human controlled user interface, comprising:
presenting on a display a perspective of a virtual object comprising a representation of an exterior of a real world object, including presenting a set of interactive elements on the physical object, the interactive elements providing additional information regarding the physical object when engaged by the user;
tracking movements of the user in a confined space proximate to a capture device;
responsive to the user movements, altering the virtual perspective of the physical object within the virtual space about the physical object coincident with the user movement relative to the capture device; and
responsive to a user selection of an interactive element, providing the additional information associated with the virtual object, the information including at least a different visual perspective of a second portion of the virtual object.

2. The method of claim 1 further including presenting the interactive elements in the virtual perspective dependent upon the virtual perspective relative to the position of the interactive element on the object.

3. The method of claim 2 wherein a subset of the interactive elements is hidden from view in a first virtual perspective, and the subset of interactive elements is displayed in a view in a second virtual perspective.

4. The method of claim 1 wherein one or more of the interactive elements triggers one or more of a transitional animation or an informational animation.

5. The method of claim 1 wherein one or more interactive elements includes a natural manipulative movement relative to the physical object requiring an equivalent physical movement by the user in the confined space for interaction with the element.

6. The method of claim 1 wherein the altering the virtual perspective provides unlimited views of the virtual space.

7. The method of claim 1 wherein the altering the virtual perspective allows a user to completely circumvent the physical object in the virtual space.

8. The method of claim 1 wherein the movements of the user include at least a set of physical navigational movements translated into movements changing the virtual perspective and another set of movements corresponding to a trigger enabling motion within the virtual environment.

9. A computer implemented method of navigating about a virtual object using a human controlled interface, comprising:
presenting on a display a virtual perspective view of a virtual object comprising a representation of an exterior of a real world object, the virtual object having an exterior in virtual space capable of being viewed from any number of virtual perspectives completely surrounding the object;
tracking movements of a user in a confined space proximate to the display, the movements directing a change in the virtual perspective of the virtual object;
responsive to the user movements, altering the virtual perspective of the physical object to one of the number of virtual perspectives, the altering comprising:
responding to a movement of a user in a direction relative to the motion of the user which mimics the motion of the user or
responding to a movement triggering a specific movement of the virtual perspective.

10. The method of navigating about a virtual object of claim 9, further including:
displaying interactive elements on the physical object, the interactive elements providing additional information regarding the physical object when the interactive element is engaged by the user; and
responsive to a user selection of an interactive element, providing information associated with the virtual object, the information including a different visual perspective of a second portion of the virtual object.

11. The method of navigating about a virtual object of claim 10 wherein the step of displaying includes displaying the interactive elements on the physical object relative to the virtual perspective, with a subset of the interactive elements being visible in the virtual perspective view at a time.

12. The method of claim 11 wherein a subset of the interactive elements is hidden from view in a first virtual perspective, and the subset of interactive elements is displayed in a view in a second virtual perspective.

13. The method of claim 12 wherein one or more of the interactive elements triggers one or more of a transitional animation or an informational animation.

14. The method of claim 13 wherein one or more interactive elements includes a natural manipulative movement relative to the physical object requiring an equivalent physical movement by the user in the confined space for interaction with the element.

15. In a computer system having a graphical user interface including a display and a user interface selection device, a method of viewing and selecting items in a menu on the display, comprising the steps of:
presenting a virtual perspective view of a virtual object comprising a representation of real world object on a display, the virtual object having an exterior in virtual space capable of being viewed from virtual perspectives in virtual space equivalent to real world perspectives viewable by a user around a real world version of the real world object;
tracking movements of a user in a confined space proximate to a capture device;
responsive to the user movements, altering the virtual perspective of the physical object;
providing a set of interactive elements on the physical object, the interactive elements providing additional information regarding the physical object when engaged by the user;
displaying the interactive elements on the physical object relative to the virtual perspective, a subset of the interactive elements being visible in the virtual perspective view at a time;
responsive to a user selection of an interactive element, providing information associated with the virtual object, the information including providing at least one of a different visual perspective of a portion of the virtual object or additional detail about a portion of the virtual object.

16. The method of claim 15 wherein the step of altering comprises:
responding to a movement of a user in a direction relative to the motion of the user which mimics the motion of the user or
responding to a movement triggering an specific movement of the virtual perspective.

17. The method of claim 16 presenting the interactive elements in the virtual perspective dependent upon the virtual perspective relative to the position of the interactive element on the object.

18. The method of claim 17 wherein one or more of the interactive elements triggers one or more of a transitional animation or an informational animation.

19. The method of claim 18 wherein one or more interactive elements includes a natural manipulative movement relative to the physical object requiring an equivalent physical movement by the user in the confined space for interaction with the element.

20. The method of claim 19 wherein the altering the virtual perspective provides unlimited views of the virtual space.
